(19) United States
(12) Patent Application Publication
(10) Pub. No.: US 2013/0171593 A1
(43) Pub. Date: Jul. 4, 2013

(54) SYSTEMS AND METHODS FOR ENCOURAGING REGULAR PARTICIPATION IN TRAINING AND COLLABORATIVE ACTIVITIES THROUGH A GAMIFIED TRAINING PLATFORM

(71) Applicant: Pepper Technology LLC, Washington, DC (US)

(72) Inventors: Dirk Gorman, Long Beach, NY (US); Branden Hall, Hyattsville, MD (US)

(73) Assignee: Pepper Technology LLC, Washington, DC (US)

(21) Appl. No.: 13/725,795

(22) Filed: Dec. 21, 2012

Related U.S. Application Data
(60) Provisional application No. 61/581,920, filed on Dec. 30, 2011.

(51) Int. Cl. G09B 5/00

(52) U.S. Cl. CPC G09B 5/00
USPC 434/219

(57) ABSTRACT

Systems and methods for encouraging regular participation in training and collaborative activities by employees of an organization are provided through a gamified training platform. Preferably, these systems and methods are implemented in an Internet based environment accessed by the employees from various types of mobile devices. A training activity is determined based on training modules pertaining to the organization and made accessible to the employees for a specified period. When a first employee performs the training activity, the platform generates a collaborative review activity that allows other employees to review the first employee's training performance. When a second employee performs the collaborative review activity, the platform generates a collaborative feedback activity that allows yet other employees to rate the second employee's review. In certain embodiments, the platform may generate a leaderboard displaying the relative ranking of the employees based on the employees' performance of the training and collaborative activities.

### CROSS-REFERENCE TO RELATED APPLICATIONS

The present application claims benefit to U.S. Provisional Patent Application No. 61/581,920, which was filed on Dec. 30, 2011. The contents of the above-identified application is incorporated by reference in its entirety as if recited in full herein.

### FIELD OF THE INVENTION

The present invention generally relates to systems and methods for training and evaluating personnel and other individuals associated with an organization. More specifically, certain embodiments are directed to systems and methods for encouraging employees and others to participate in regular training and collaborative activities through an Internet-based training and evaluation platform. According to certain of these embodiments the training and evaluation platform creates a competitive, gamified training environment by allowing employees to perform regular group-based training activities, receive and provide feedback and assistance from their peers and supervisors, and track their performance in activities through the platform relative to other users.

### BACKGROUND OF THE INVENTION

In today's age of quality management, global competition, and rapidly-changing technology, employers and organizations are in constant need of novel and improved methods for training and evaluating their employees and personnel. One important characteristic for successful and effective training models is the ability to inspire the employees or users to participate in regular training activities in order to continuously advance their knowledge and skills and/or to become certified in various fields. Another important feature that facilitates effective training is the extent to which such methods promote collaboration amongst the employees or users. It is well known that consistent and continuous training (i.e., practice makes perfect) and high-levels of collaboration and support within a group of employees (i.e., a team atmosphere) generally results in an overall improvement and increase to the efficacy and successfulness of a company's work-force.

Despite the known importance of a regular training process and a collaborative work-place, many professions and industries lack any formal training process. While certain professions, such as law, medicine and accounting, may encourage or require some continual training and education in order to practice, the training in these professions is typically of a minimal and sporadic nature. Even where such limited formal training does exist, employers are typically required to hire consultants and/or hold courses in order to provide such training to employees. Also, these courses often involves the training of all, or a large number of, employees at once to maximize efficiency, which requires removing these employees from work-related tasks to participate in training.

Moreover, in order to encourage employee participation, employers frequently need to offer a reward to an employee who gets trained, advances, and/or becomes certified in a particular area or for a particular cause. This is especially true given that employees are generally required to devote additional time outside of their standard work day in order to participate in training and educational activities. As a result, employers often find it challenging to motivate employees to give up part of their “free time” without offering financial or other types of incentives in exchange for performing such activities. Accordingly, this current form of training results in significant costs to employers, such as the fees associated with paying consultants, loss of employee work-hours and incentivizing employee participation in training activities.

The need for novel approaches to training and evaluating employees and other personnel is particularly important in certain companies, such as sales organizations, where there has typically been no meaningful incorporation of any formal training procedures. For example, sales personnel frequently undergo some amount of training initially, such as when they first enter the sales profession or switch industries, either by participating in training activities or simply learning on-the-job. After this initial training process, however, sales people typically engage in little or no continued sales training or education. As a result, the ability and effectiveness of sales personnel often plateaus and their sales knowledge and skills fail to improve. This stagnant approach to sales training and improvement is further compounded by an overall lack of emphasis in the sales profession on the need for, or the benefits associated with, participation in any form of regular training. Also, the highly competitive atmosphere and “zero-sum” attitude that is prevalent throughout the sales industry tends to result in little or no collaboration between a company's sales personnel, which further exacerbates the lack of ongoing improvement and advancement of the skills and knowledge that maximizes the effectiveness and success of a sales-force.

In addition, business users and employees (like all consumers) are becoming increasingly reliant on various types of mobile devices, such as smart-phones, tablet PCs, PDAs, and other similar devices as their primary lifestyle and workplace productivity tool. For example, devices such as the Blackberry, Android and iPhone smartphones provide millions of users with access to mobile, internet-connected content through standardized operating platforms. These smartphones and other mobile devices (e.g., tablets, laptops PDAs) have evolved into complex computing devices with equally complex software that are used by individuals to perform and assist with a wide range of personal and work-related tasks. While many of these mobile devices continue to be used for various forms of communication (e.g., voice calls, e-mails, and text messaging) they also generally provide other various functionalities, including accessing and displaying websites, taking and displaying photographs and videos, playing music and other forms of audio, etc. In turn, the development and use of software applications designed specifically for operation and/or display on mobile devices, such as web applications accessed through a mobile web browser and mobile applications that run on mobile devices, has become widespread.

As a result, new approaches to training should take advantage of the extensive use of and reliance upon these mobile devices in order to maximize the effectiveness of, and participation in, these training programs. For example, one significant benefit associated with the use of mobile devices is the ability for employees to access and participate in training and collaborative activities from virtually any location. This is especially beneficial for companies in certain industries, such as sales companies and various types of service-based organizations that are rely on a mobile work-force or include employees that spend a substantial amount of time in the field Notwithstanding the ever-increasing prevalence of mobile devices and mobile-specific software applications, there has been little or no development related to providing training and evaluation models that capture the capabilities and widespread use of such devices.

There have been some previous attempts to provide computer-based training systems to employees and other users over a network. For example, U.S. Pat. No. 6,589,055 discloses a system and method for computer aided training and certification that employs a central network for storing certification information and a plurality of training units. In preferred embodiments, the training units are individual systems comprising training software running on a turn-key based personal computer. The software may be customized for each training unit to provide instruction using customized multi-media content, such as high quality digital video footage, taken of the trainee's specific job tasks and work site, as well as questions and instructional scripts customized for the job tasks and work site.

Similarly, U.S. Pat. No. 6,377,781 discloses a system that provides a session for a quiz on a computer system. The system operates by receiving a request to create a session for the quiz. In response to the request, the system creates the session. This session provides a mechanism through which a selected group of people can take the quiz. The system also associates the session with an owner of the session in order to facilitate channeling results generated by the selected group of people in taking the quiz to the owner of the session. Next, the system makes the session for the quiz available over a network so that the selected group of people can take the quiz from remote nodes on the network. Upon receiving the results from the selected group of people taking the quiz, the system communicates the results to the owner of the session. In one embodiment, the owner of the session for the quiz is an educator, and the selected group of people are students of the educator.

These prior art training systems, however, have exhibited a number of drawbacks and limitations which have resulted in their failure to be widely adopted by organizations and consumers. One such drawback is that many of these systems require the use of fixed desktop computers or workstations. Similarly, many of these systems require the user to download and install client application. As a result, these systems do not allow users to access the training platform and participate in training and collaborative activities through mobile and other types of devices and/or from virtually any location. Another drawback is that many of these systems fail to promote collaboration amongst the users, such as through interactive feedback and peer reviews. Yet another drawback is that many of these systems lack the incentives or rewards needed to motivate users to participate in consistent and continuous training and collaborative activities. Still yet another drawback is that many of these systems do not provide any meaningful ability for employers or high-level employees to evaluate the performance and activities of the employees and other individuals participating in the training and collaboration platform. Still yet another drawback is that many of these systems do not provide for training activities and content that can be easily customized, updated, supplemented, replaced and/or removed based on the needs of the organization.

There is, therefore, a need for a computer-based system for training and evaluating users, such as employees or other individuals associated with an organization. There is also a need for such a system that provides users with training and collaborative activities through an enhanced, user-friendly training platform. There is further a need for such a system that allows users to access the training platform from virtually any location through a wide range of user devices. There is still further a need for such a system that takes advantage of the capabilities and functionalities of modern smartphones and other types of mobile devices. There is still further a need for such a system that requires little or no software installation on the users' devices. There is still further a need for such a system that simplifies and enhances the ability to add, replace, update, and customize the training activities, training formats, and training content offered through the training platform. There is still further a need for such a system that encourages regular and consistent participation by users in training activities and promotes a collaborative training environment. There is still further a need for such a system that allows an organization to track and evaluate the participation and performance of the users in training and collaborative activities through the training platform.

The above and other needs are addressed by the Systems and Methods for Encouraging Regular Participation in Training and Collaborative Activities through a Gamified Training Platform disclosed herein.

### SUMMARY OF THE INVENTION

One aspect of the invention is to provide a training platform that allows users associated with an organization to access and perform training and collaborative activities. Another aspect of the invention is to provide such a platform that is accessible to users over the Internet through a wide range of mobile devices from virtually any location. Yet another aspect of the invention is to provide such a platform in the form of a web application that allows users to participate in training and collaborative activities without having to download or install any separate software on their mobile devices. Yet another aspect of the invention is to provide such a platform that allows users to participate in a variety of different training formats and categories. Yet another aspect of the invention is to provide such a platform in which the training categories and formats can be easily updated, added to and removed from the platform, and customized for a particular organization. Yet another aspect of the invention is to provide such a platform that allows users to provide and receive feedback and assistance from their peers and supervisors. Yet another aspect of the invention is to provide such a platform that allows users to participate in frequent and ongoing training and collaborative activities.

Another aspect of the invention is to provide a gamified training platform that encourages regular and consistent participation in training and collaborative activities by users. Yet another aspect of the invention is to provide such a platform that promotes a competitive training environment by awarding points to users based on their participation and performance in training and collaborative activities and presents the ranking of each user's points to all of the users through the platform. Yet another aspect of the invention is to provide such a platform that assigns each user a role based on their position in the organization that determines the types of activities and parts of the platform that the users can access. Yet another aspect of the invention is to provide such a platform that includes an evaluation platform for tracking and evaluating the users' participation and performance of training and collaborative activities. Yet another aspect of the invention is to provide such a platform that allows the organization and/or certain types of users to analyze the users' participation and performance through the platform in order to determine areas of information or skills that need additional training and/or to identify candidates for certain positions within the organization.

One or more of the above and other aspects may be realized through systems and methods, including computer hardware and/or software and related components for providing a training and evaluation platform. In certain embodiments, a gamified training and evaluation platform and corresponding arrangements is provided to address concerns facing employers and organizations, such as regular participation in training activities, collaboration amongst users, customizability of training content and formats, cost of motivation, and meaningful evaluation of user performance. Certain embodiments encourage consistent and continual participation in training and collaborative activities by creating a competitive training environment.

In certain embodiments, a system and method is provided for encouraging regular participation in training and collaborative activities by employees of an organization. In certain of these embodiments, training data is stored that includes training modules, each having a number of training activities. User data may also be stored that is associated with a number of employees of the organization. In certain embodiments, a gamified training platform is provided, which allows the employees to access and perform various training and collaborative activities. In certain embodiments, a training activity is determined based on the training data and is made accessible to the employees through the gamified training platform for a specified period. When a first employee performs the training activity, training response data is received. In certain of these embodiments, a collaborative review activity is generated based on the training response data, which allows other employees to review the first employee's performance of the training activity. In certain embodiments, collaborative review data may be received when a second employee performs the collaborative review activity. In certain of these embodiments, a collaborative feedback activity may be generated based on the collaborative review data, which allows yet other employees to rate the second employee's performance of the collaborative review activity. In certain embodiments, the user data may be updated based on the training response data and/or the collaborative review data. In certain of these embodiments, the user data enables the employees to access a leaderboard that indicates the relative ranking of the employees.

In certain embodiments, the gamified training platform is provided in the form of a web based application that is accessed by the users through the Internet. In certain of these embodiments, the web based application is adapted for display on various types of mobile devices, such as smartphones, laptops, tablets, and PDAs. In certain embodiments, the training data, user data, and/or ranking data may be stored in one or more databases that can be accessed over a network. In certain embodiments, the gamified training platform may include a number of gamified training platforms, each of which is accessible to a subset of the employees.

In certain embodiments, the training data may include a number of training modules, each of which are associated with various training activities. In certain of these embodiments, the training modules may include a training activity type that indicates the training content category and/or the training format of the training activities associated with the training module. In certain of these embodiments the training content category may be related to a customer, job position, product or service, policy, area of compliance, skill or field of expertise associated with the organization. In certain embodiments, the training format may be multiple-choice, true-false, short answer, essay or simulation. In certain embodiments, training activities may be determined for the employees on a continual basis at the beginning of each specified period and made accessible to the employees through the gamified training platform for the specified period. In certain of these embodiments, the specified period may be daily, weekly, or monthly.

In certain embodiments, the user data includes a user role for each of the employees that may selected from a number of predefined user roles. The user role for each employee may be based, at least in part, on the employee's position within the organization. In certain of these embodiments, access to one or more training and collaborative activities may be restricted to the employees who are associated with one or more of the predefined user roles.

In certain embodiments, the user data includes historical activity data for the employees that relates to various training and collaborative activities that each employee has previously performed through the gamified training platform. In certain of these embodiments, the historical activity data associated with the first employee and the second employee may be updated based on the training response data and the collaborative review data. In certain embodiments, collaborative feedback data may be received from a third employee who performs the collaborative feedback activity and the historical activity data associated with the first second and/or third employees may be updated based on the collaborative feedback data. In certain embodiments, an evaluation platform may be provided that assists evaluators associated with the organization in tracking and analyzing the performance of the employees in training and collaborative activities through the gamified training platform based on the historical activity data. In certain embodiments, the ranking data may be determined in response to an employee requesting access to the global leaderboard, based on the historical activity data associated with each employee.

### BRIEF DESCRIPTION OF THE DRAWINGS

Further features of the invention, its nature and various advantages will be more apparent from the following detailed description of the preferred embodiments, taken in conjunction with the accompanying drawings, in which like reference characters refer to like parts throughout, and in which:

FIG. 1 is a pictorial diagram of a system including a training and evaluation platform in accordance with certain embodiments;

FIG. 2 is a pictorial diagram of a system including a training and evaluation platform in accordance with certain other embodiments;

FIG. 3 is a pictorial diagram of a system including a training and evaluation platform in accordance with yet other embodiments;

FIG. 4 is a flowchart illustrating a training and collaboration process that may be performed using the training and evaluation platform in accordance with certain embodiments;

FIG. 5 is a pictorial diagram illustrating a portion of the display of a training application having a user login page that may be presented to users of the training and evaluation platform, according to certain embodiments;

FIG. 6A is a pictorial diagram illustrating a portion of the display of a training application having a home navigation page that may be presented to users of the training and evaluation platform, according to certain embodiments;

FIG. 6B is a pictorial diagram illustrating a portion of the display of a training application having a home navigation page that may be presented to users of the training and evaluation platform, according to certain other embodiments;

FIG. 6C is a pictorial diagram illustrating a portion of the display of a training application having a home navigation page that may be presented to users of the training and evaluation platform, according to yet other embodiments;

FIG. 7A is a pictorial diagram illustrating a portion of the display of a training application having an assignments page that may be presented to users of the training and evaluation platform, according to certain embodiments;

FIG. 7B is a pictorial diagram illustrating a portion of the display of a training application having a my assignments page including one or more previously completed training activities that may be presented to users of the training and evaluation platform, according to certain embodiments;

FIG. 7C is a pictorial diagram illustrating a portion of the display of a training application having a previously completed training activity page that may be presented to users of the training and evaluation platform, according to certain embodiments;

FIG. 8A is a pictorial diagram illustrating a portion of the display of a training application having a my reviews page including one or more previously completed collaborative review activities that may be presented to users of the training and evaluation platform, according to certain embodiments;

FIG. 8B is a pictorial diagram illustrating a portion of the display of a training application having a previously completed review activity page that may be presented to users of the training and evaluation platform, according to certain embodiments;

FIG. 9A is a pictorial diagram illustrating a portion of the display of a training application having a training activity page including a multiple-choice activity that may be presented to users of the training and evaluation platform, according to certain embodiments;

FIG. 9B is a pictorial diagram illustrating a portion of the display of a training application having a training activity page including a true-false activity that may be presented to users of the training and evaluation platform, according to certain embodiments;

FIG. 9C is a pictorial diagram illustrating a portion of the display of a training application having a training activity page including a short-answer activity that may be presented to users of the training and evaluation platform, according to certain embodiments;

FIG. 9D is a pictorial diagram illustrating a portion of the display of a training application having a training activity page including a voice simulation activity that may be presented to users of the training and evaluation platform, according to certain embodiments;

FIG. 10 is a pictorial diagram illustrating a portion of the display of a training application having a training activity results page that may be presented to users of the training and evaluation platform, according to certain embodiments;

FIG. 11A is a pictorial diagram illustrating a portion of the display of a training application having a collaborative activity page associated with reviewing another user's performance of a training activity that may be presented to users of the training and evaluation platform, according to certain embodiments;

FIG. 11B is a pictorial diagram illustrating a portion of the display of a training application having a collaborative activity page associated with reviewing another user's performance of a training activity that may be presented to users of the training and evaluation platform, according to certain embodiments;

FIG. 12 is a pictorial diagram illustrating a portion of the display of a training application having a collaborative activity page associated with rating another user's review that may be presented to users of the training and evaluation platform, according to certain embodiments;

FIG. 13A is a pictorial diagram illustrating a portion of the display of a training application having a leaderboard page that may be presented to users of the training and evaluation platform, according to certain embodiments;

FIG. 13B is a pictorial diagram illustrating a portion of the display of a training application having a leaderboard page that may be presented to users of the training and evaluation platform, according to certain other embodiments;

FIG. 14A is a pictorial diagram illustrating a portion of the display of a training application having an activity rollup navigation page that may be presented to users of the training and evaluation platform, according to certain embodiments;

FIG. 14B is a pictorial diagram illustrating a portion of the display of a training application having an activity rollup summary page that may be presented to users of the training and evaluation platform, according to certain embodiments;

FIG. 14C is a pictorial diagram illustrating a portion of the display of a training application having an activity rollup activity page that may be presented to users of the training and evaluation platform, according to certain embodiments;

FIG. 15A is a pictorial diagram illustrating a portion of the display of a training application having a favorites navigation page that may be presented to users of the training and evaluation platform, according to certain embodiments;

FIG. 15B is a pictorial diagram illustrating a portion of the display of a training application having a favorites activity page that may be presented to users of the training and evaluation platform, according to certain embodiments; and

FIG. 16 is a pictorial diagram illustrating a portion of the display of a training application having a question and answer page that may be presented to users of the training and evaluation platform, according to certain embodiments.

### DETAILED DESCRIPTION OF THE INVENTION

As discussed above, employers and organizations often have a difficult time motivating employees and other users associated with the organization to participate in training activities and collaborate with and assist other employees or users. This is especially true for certain industries or for certain types of organizations in which the participation in any kind of formal training and collaboration process has previously been non-existent or even disfavored, and/or in which the organization is reliant on a substantially mobile work-force. To encourage the regular participation in training and collaboration by such employees and users, systems and methods are provided herein that allow users to access training and collaborative activities using a wide range of mobile and other kinds of user devices from virtually any location.

Certain embodiments of the present invention pertain to a computer-based training and evaluation platform, including computer hardware and/or software, for training and evaluating employees (e.g., sales-force employees), other members of an organization and/or other types of users. According to certain of these embodiments the training and evaluation platform allows employees (e.g., sales personnel) and other users to participate in regular training and collaborative activities and receive and provide feedback and assistance from peers and supervisors. Certain embodiments allow users to access the training and evaluation platform over the Internet through a wide range of mobile devices from virtually any location and/or without having to download or install any separate software on their mobile devices. Certain embodiments allow users to participate in a variety of different training formats and categories, which may be easily updated, added to and removed from the platform, and customized to suit the needs of a particular organization. According to certain of these embodiments, the training platform is provided in the form of a gamified training platform that encourages regular and consistent participation in training and collaborative activities by creating a gamified training environment that awards points to users and presents the users' relative rankings through the platform. According to certain embodiments the platform includes an evaluation platform that allows the organization and/or certain authorized personnel to track and evaluate the users' participation and performance in training and collaborative activities through the platform.

The training and evaluation platform, corresponding arrangements and systems and methods described below address many of the hurdles and restrictions that currently exist with respect to training and evaluation employees and other users associated with an organization and encourages consistent participation in training and collaboration by creating a competitive training environment, in which training and collaborative activities are accessible through virtually any Internet-enabled device from any Internet-accessible location, thereby minimizing the time and effort involved.

### Training and Evaluation Platform and System Architecture

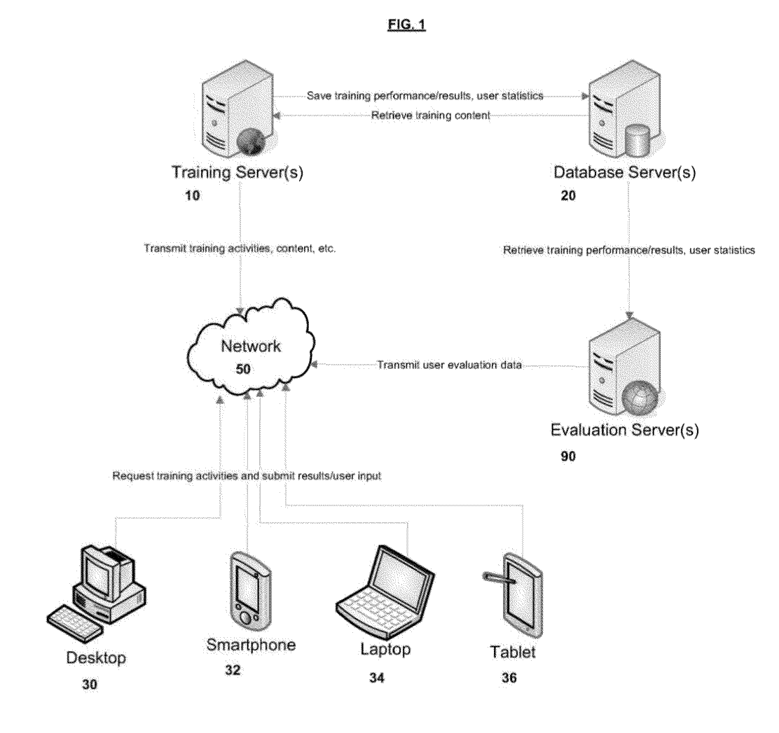

In certain embodiments, the training and evaluation platform may be provided through any suitable form of hardware, software or a combination of hardware and software that allows users to participate in training and collaborative activities. In certain of these embodiments, the training and evaluation platform may be provided in the form of a software application that is accessed by users through a range of mobile devices and other suitable computing devices over a network using a client-server model. One advantage of using this type of application is the ability for users to easily access and interact with the training and evaluation platform from virtually any location without the need to download and install any software on their user device. Exemplary illustrations of the architecture of the training and evaluation platform and accompanying systems and components, in accordance with certain embodiments, are shown in FIGS. 1-3 and described below.

FIG. 1 is a pictorial diagram of a system including a training and evaluation platform in accordance with certain embodiments. As shown in FIG. 1, this system includes servers, processors, networks, and personal devices which are part of the training and evaluation platform. The system of FIG. 1 includes training server 10, which may be computer hardware, software, or a combination thereof, including any number of physical or virtual computer servers, or any other suitable computing device or devices. In certain embodiments, training server 10 hosts, operates and/or provides access to a training service which can be accessed by various users, such as employees or other users associated with an organization and/or any other types of users who desire to participate in training and collaborative activities. In certain embodiments, the training service may be in the form of a training application running on training server 10 and accessed by users through network 50. In certain of these embodiments, training server 10 may be maintained and operated by a company or organization that desires to provide its employees or other users associated with the organization access to the training and collaborative activities through the training and evaluation platform. In certain other embodiments, training server 10 may be maintained and operated by a third-party service provider, such as a third-party service provider that hosts and operates the training and evaluation platform on behalf of one or more related or unrelated organizations.

In certain of these embodiments, training server 10 may be responsible for managing and responding to requests from client or user devices desiring access to the training application. For example, in certain embodiments, users may access training server 10 through various types of user devices, such as desktop computer 30, smartphone 32, laptop 34, and/or tablet 36, as depicted in FIG. 1. In certain other embodiments users may access the training application through any type of user device, such as smartphones, tablets, PDAs, laptops, PCs, other types of mobile, handheld or portable devices or any other suitable computer hardware and/or software that is capable of communicating with, and/or providing users with access to, training server 10 via network 50. In certain of these embodiments, network 50 may be any suitable type of wired and/or wireless network, such as an Internet network or dedicated network that allows users to access to training server 10 through user devices, such as user devices 30, 32, 34, and 36. Although training server 10 is shown as a single server in FIG. 1 for illustrative purposes, it should be understood that in certain embodiments the functionality provided by training server 10, such as the training and collaboration application, may be hosted and operated by any number of servers or similar components.

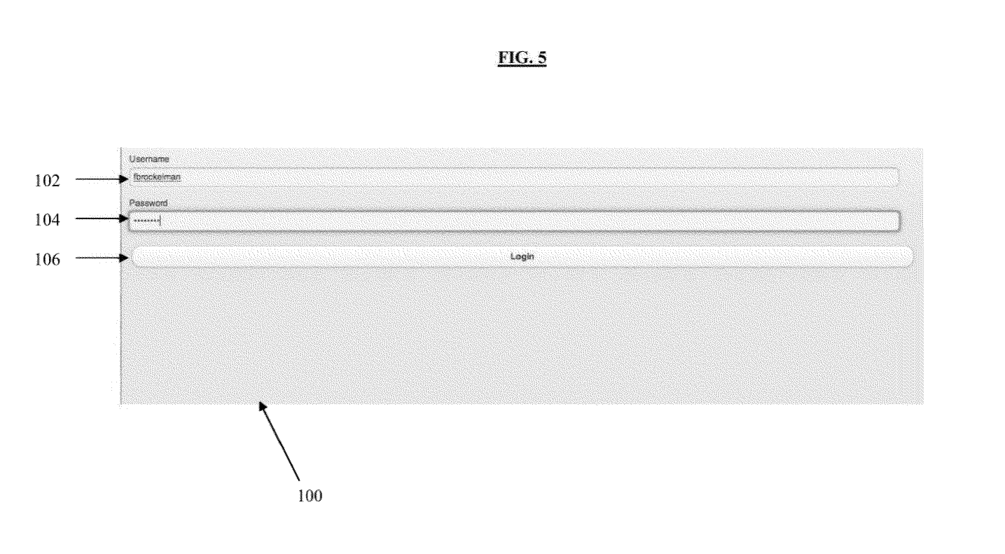

In certain embodiments, the training application may be in the form of a web based service, such as a web application, in which case training server 10 may be a web server and network 50 may be the Internet. In certain of these embodiments, users may access the web application through a website hosted by training server 10. For example users may access the training application by navigating to one or more web pages using a standard web browser on their user devices, thereby obviating the need to download and/or install separate software on user devices 30, 32, 34, and 36. In certain of these embodiments, the web application may be designed primarily for use by, and display on, mobile devices (i.e., a mobile web application). In certain of these embodiments, training server 10 may host a number of web pages, which may correspond to portions of the training and evaluation platform, and are delivered to users accessing the platform through various Internet-enabled devices. Exemplary web pages provided by a web based training application in accordance with certain embodiments are illustrated and described in further detail below in connection with FIGS. 5-16.

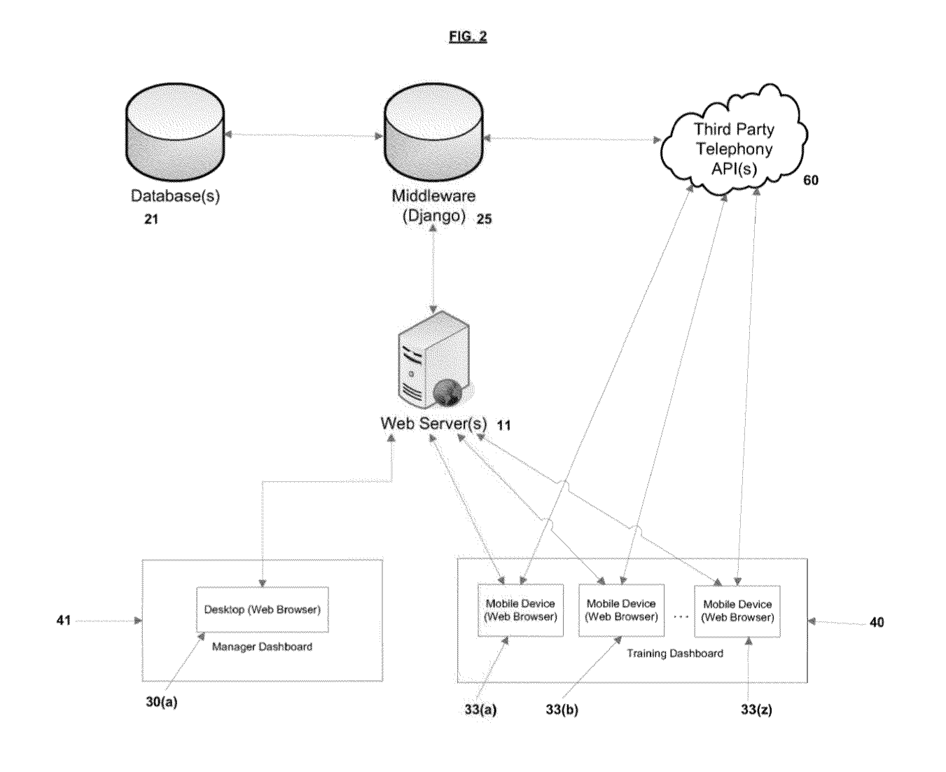

In certain other embodiments, the training service or application may be accessed through a separate client or stand-alone software application that can be downloaded by users from training server 10 and/or one or more other third-party servers, or may be provided to users through any other suitable means (e.g., CD, physical disk, etc.) and installed on user devices, such as user devices 30, 32, 34, and 36. For example, users may be required to download and install a software application on their user devices, such as a mobile application (i.e., mobile app). The users may download the mobile application from training server 10, web server shown in FIG. 2, or any other server, such as a third-party server associated with a digital distribution platform (e.g., Apple's App Store). In certain of these embodiments, after downloading the mobile app, the app may connect to the server to request various information, such as updates or training content to be used in connection with the training application and/or presented to users and provide certain data to the server, such as performance results and user input. In yet other embodiments, the training and evaluation platform may be in the form of a stand-alone software application that may be installed on a personal computer, laptop, or similar device.

As described in more detail below, the training and evaluation platform may include the ability to view, monitor, analyze and evaluate the participation and/or performance of users or groups of users of the training and evaluation platform. In certain of these embodiments, some or all of the features and functionalities associated with tracking and evaluating employees may be provided through a separate application, such as mobile web application operated and/or hosted by evaluation server 90, as illustrated in FIG. 1. In certain other embodiments, such as is illustrated in FIG. 2 and described below, the features and functionalities associated with evaluating employees may be included within the training service or application and/or provided by the same server that operates and hosts the training portion of the application (e.g., training server 10). In certain embodiments, such as is shown in FIG. 1, users may access the evaluation application or service from various types of user devices (e.g., user devices 30, 32, 34, and 36) through network 50. In certain of these embodiments, access to the evaluation application may be restricted to certain types of users, such as high-level employees or users associated with a particular user role in the training and evaluation platform. In certain other embodiments, users may be required to access the evaluation application through a dedicated or similar type of network, such as an intranet associated with the organization.

In certain of these embodiments, information associated with each of the users' use of various aspects of the training application, such as the users' participation and/or performance in training and collaborative activities, may be stored in user tracking data by training server 10 at database server 20. In certain embodiments, the training and evaluation platform may allow an organization (e.g., high-level employees) to utilize this tracking data in order to track and analyze various parameters associated with the users of the platform. For example, the tracking data may be accessed through the evaluation application to view the performance of individual users, identify certain areas in which one or more users need further training, and/or identify “star” employees or users based on various criteria and metrics.

As shown in FIG. 1, in certain embodiments, training server 10 and/or evaluation server 90 may also utilize one or more database servers, such as database server 20. In certain embodiments, database server 20 may store various predefined or generic training data, such as various types of training modules, activities and/or exercises that can be retrieved by training server 10 and presented to users who are participating in training or collaborative activities through the training and evaluation platform. In certain of these embodiments, database server 20 may be used by training server 10 and or evaluation server 90 to store and retrieve various other types of data created and/or utilized in connection with the training and evaluation platform. For example, database server 20 may be used to store user data associated with the users, collaboration data associated with various collaborative activities, ranking data associated with user scores and/or points awarded for participation and performance in training and collaborative activities, tracking data associated with tracking the users' use of the platform and any other related data for the users or the organization that is stored by training server 10 and/or evaluation server 90 in response to the training and collaborative activities and other actions of users in connection with the training and evaluation platform. In certain of these embodiments, the various types of data may be stored in one or more databases on database server 20.

In certain embodiments, database server 20 may be hosted and operated by a third-party service provider. The third-party service provider may be a separate service provider or may be the same service provider hosting and operating training server 10 and/or evaluation server 90. In certain embodiments, training server 10 and/or evaluation server 90 may access, and communicate with, database server 20 through network 50. In certain of these embodiments, training server 10 and/or evaluation server 90 may access, and communicate with, database server 20 through various intermediary hardware or software, such as a “middleware server” as is illustrated in FIG. 2. In certain other embodiments, database server 20, or a portion of it, may be integrated with (or directly connected to) training server 20 and/or evaluation server 90.

FIG. 2 is a pictorial diagram of a system including a training and evaluation platform in accordance with certain other embodiments. As shown in FIG. 2, in certain embodiments, such as where the training and evaluation platform is provided in the form of a mobile web application, certain features and functionality associated with the platform may be provided through one or more graphical interfaces (e.g., a series of webpages) or dashboards, such as Training Dashboard 40 and/or Manager Dashboard 41. For example, in certain of these embodiments, Training Dashboard 40 may be associated with a training and collaboration portion of the mobile web application, and Manager Dashboard 41 may be associated with an evaluation portion of the application. In certain embodiments, Training Dashboard 40 and Manager Dashboard 41 may be provided as separate mobile web applications. In certain other embodiments, the two dashboards may be separate portions of the same mobile web application, in which case the portion of the application associated with Manager Dashboard 41 may only be accessible and/or viewable by certain users or groups of users.

In certain of these embodiments, users of the training and evaluation platform may access Training Dashboard 40 through mobile devices 33(a)-(z), which may be one or more types of mobile or other portable devices, such as by connecting to web server 11 via the Internet through a browser application available on mobile devices 33(a)-(z), as illustrated in FIG. 2. Similarly, users may access Manager Dashboard 41 through a web browser available on desktop computer 30(a), which may be any type of desktop or laptop computer or workstation, such as by connecting to web server 11 via the Internet. In certain embodiments, these users may also access Manager Dashboard 41 through other types of devices, such as smartphones, tablets, and other forms of mobile and portable devices. In certain embodiments, access to Manager Dashboard 41 may be restricted to certain users authorized by the organization, such as managers or higher-level employees.

In certain of these embodiments, the mobile web application may be based on a mobile framework (e.g., jQuery Mobile), which allows the web application to be accessible from all (or substantially all) major smartphone and tablet operating systems including iOS, Android, and Blackberry. As a result, users can easily navigate to their instance of the web application in the web browser on their (or any other) smartphone, tablet, or other mobile device from any location. In certain embodiments, the mobile web application may also be implemented using various rich-media content and/or modern web formats, such as HTML5, in order to create an engaging user experience. In certain of these embodiments the mobile web application may only be accessible to user devices having a minimum wireless signal capability, such as 3G or better (e.g., WiFi).

In certain embodiments, the training and evaluation web application and/or platform may utilize various third-party software components to provide certain features and functionalities associated with the training and collaborative activities and evaluation services. For example, as illustrated in FIG. 2, the training and evaluation platform may include a middleware server 25, which may be any suitable combination of hardware and software (e.g., a server built on Django) that allows web server 11 to interface with one or more databases, such as databases associated with database server 21, which may be in the same or a similar form to database server 20 illustrated in FIG. 1. In certain of these embodiments, web server 11 may utilize middleware server 25 in order to store and retrieve various information, such as content for training and collaborative activities, data associated with performing the training and collaborative activities, reviews, ratings, feedback, questions and responses provided by users, ranking data, tracking data, and other related user data and statistics. In turn, this data may be utilized by the evaluation portion of the application, such as Manager Dashboard 41, to provide various analytical reports and metrics regarding one or more users of the training platform to high-level employees and other authorized users. In certain other embodiments, some or all of the features or functionality associated with middleware server 25 may be integrated into web server 11.

As discussed in more detail below, the training and evaluation platform may interface with various third-party services through third-party APIs, such as third-party telephony API 60 illustrated in FIG. 2, in order to enable users to access various training and/or collaborative features through the platform. In certain embodiments these third-party APIs may be utilized by the training and evaluation platform in order to allow users to participate in and perform simulation-based training activities and collaborative activities associated with reviewing one or more users' performance in the simulation. For example, third-party telephony API 60 may allow users to participate in simulated calls (e.g. sales calls), such as to practice their communications and/or customer management skills. In certain of these embodiments, the users participating in the simulation may connect directly to the third-party service through the third-party API. For example, as shown in FIG. 2, users connect to third-party telephony API 60 through mobile devices 33(a)-(z), such as via a cellular, wireless or other type of network connection, without the need to go through web server 11. In certain embodiments, such as where mobile devices 33(a)-(z) are cellular devices, this allows the users to receive, answer and respond to a simulated phone call. One example of such third party telephony APIs, which may be utilized to offer simulated calls to users of the training application is provided by Twilio Inc. (http://www.twilio.com).

Similarly, other third-party APIs may be incorporated to provide other types of training simulations or other types of training activities, such as a third-party video API that allows users to participate in video simulations, such as to simulate live interactions with customers. In certain of these embodiments, the users' participation in the simulated phone calls and/or video simulations may be recorded in audio and/or video format to allow the user and other users to view, review and/or rate the user's performance. In certain of these embodiments, the audio and/or video data may be provided to the training and evaluation platform (e.g., web server 11) through the third-party API (e.g., third-party telephony API 60) and stored in one or more databases (e.g., at database server 21). In certain other embodiments, this data may be stored directly in the database by the third-party service.

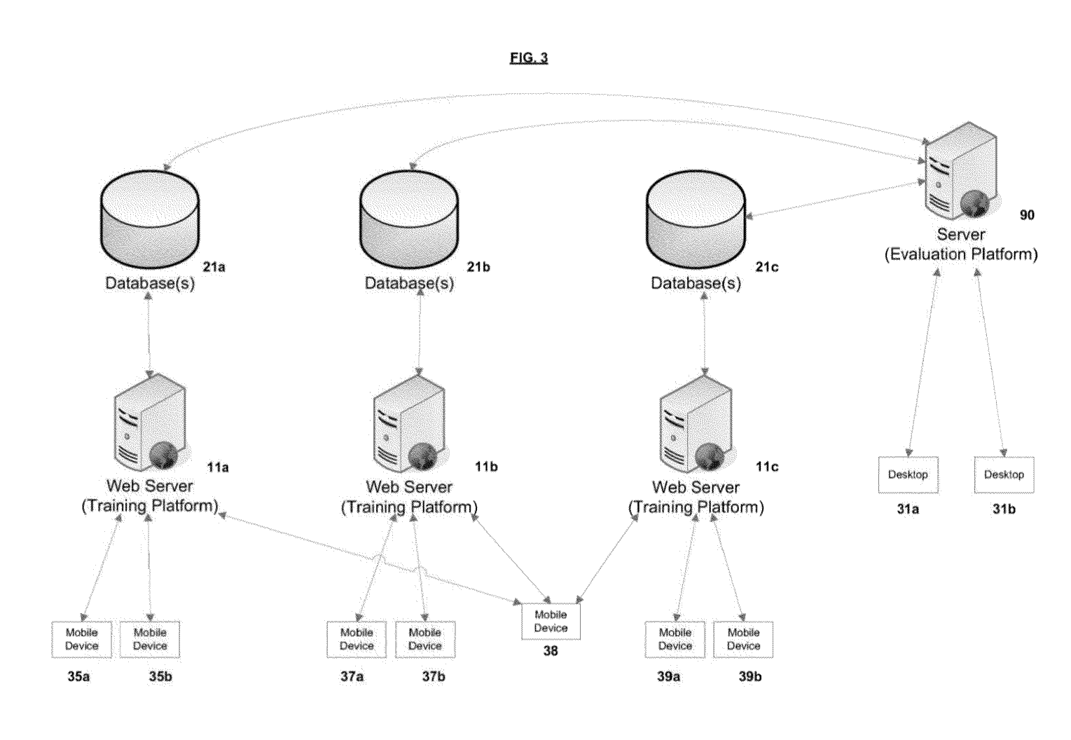

FIG. 3 is a pictorial diagram of a system including a training and evaluation platform in accordance with yet other embodiments. In certain embodiments, such as the embodiments described and illustrated in connection with FIGS. 1 and 2, the training and evaluation platform and/or mobile web application may be divided into multiple separate instances. For example, as shown in FIG. 3, the training and evaluation platform may include three separate instances of the training platform and/or training and collaboration application, each of which may be provided by a separate web server, such as web servers 11a-11c. In certain other embodiments, one or more of the separate instances of the training and collaboration application may be provided by a single physical server. In certain embodiments, web servers 11a-11c may each utilize separate databases to store data in a similar manner to that described above in connection with FIGS. 1 and 2, such as databases associated with database servers 21a-21c. In certain other embodiments, the databases used by web servers 11a-11c may be stored on a single database server and/or web servers 11a-11c may share one or more databases to store various types of data (e.g., user data and/or training data).

In certain of these embodiments, each of the separate instances of the training and collaboration application may be associated with, and may be accessed by a separate group of users, such as subsets of the users associated with an organization or groups of users associated with related or unrelated organizations. For example, as shown in FIG. 3, the training and collaboration application provided through web server 11a may be accessed and used by users associated with mobile devices 35a and 35b, while the training and collaboration applications provided through web servers 11b and 11c may be accessed and used by users associated with mobile devices 37a and 37b, and mobile devices 39a and 39b, respectively. In certain of these embodiments, certain users, such as a user associated with mobile device 38, may be able to access two or more of the separate instances of the training and collaboration applications, as illustrated in FIG. 3. In certain of these embodiments, all of the users associated with a particular user role in the platform and/or a job position within the organization may be able to access all of the instances of the application that are associated with the organization.

In certain of these embodiments, one or more instances of the training and collaboration application may be limited to a specified maximum number (e.g., 150) of employees or other users. Limiting the number of users in each instance of the application has the benefit of increasing the likelihood that the users of each instance of the application will create a collaborative and interactive training environment (e.g., a mini social network) with a higher degree of camaraderie amongst the users. In certain embodiments, such as where each user of the application is associated with a user role, a specified number of users associated with one or more of the user roles may be required for each instance of the training and collaboration application, such as to ensure that each instance has a balanced makeup of different types of users (e.g., managers, captains, coaches, players).

As shown in FIG. 3, the evaluation portion of the training and evaluation platform may be provided through evaluation server 90. In certain embodiments, evaluation server 90 may provide certain users, such as users associated with desktop computers 31a and 31b with access to an evaluation application, in a similar manner to that described and illustrated in connection with FIG. 1. In certain of these embodiments, a single evaluation application may be provided, which allows the authorized users and/or an organization to monitor and evaluate all of the user associated with each of the separate instances of the training and collaboration application, as is illustrated in FIG. 3. For example, evaluation server 90 may access various data associated with participation and performance in training and collaborative activities by the users associated with web servers 11a-11c, such as by retrieving the data from database servers 21a-21c. In certain other embodiments, a separate evaluation server and/or evaluation application may be provided for some or each of the separate instances of the training and collaboration applications. Although a specific number of web servers, evaluation servers, database servers, mobile devices, and desktop computers are shown in FIG. 3 for illustrative purposes, it should be understood that in certain embodiments the training and evaluation platform may include any number of such systems, devices, and/or components.

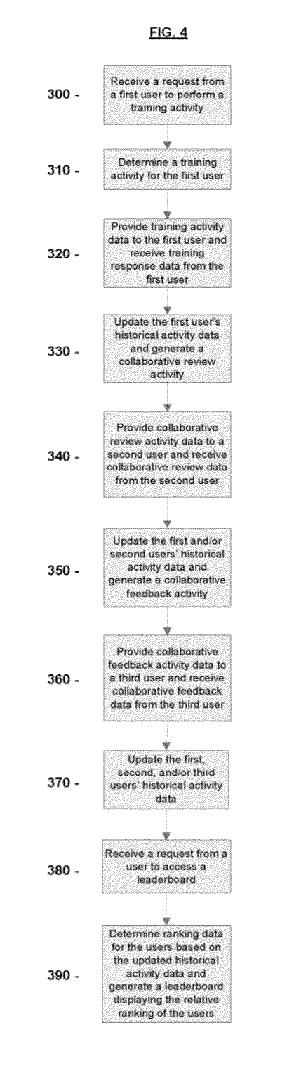

FIG. 4 is a flowchart illustrating a training and collaboration activity process that may be performed using the training and evaluation platform in accordance with certain embodiments, such as those illustrated and described in connection with FIGS. 1-3. At step 300, the training and evaluation platform receives a request from a first user to perform a training activity. In certain embodiments, such as where users access the training and evaluation platform via a web-based training application, the first user may access a website associated with the training application to request the training activity. In certain of these embodiments the first user may be asked to provide certain log-in credentials, such as a user name and/or password in order to access the training application and/or request the training activity. In certain other embodiments, such as where the training and evaluation application is accessed through a stand-alone software application or a mobile application, the first user may launch the application and select an option to perform a training activity.

After the first user has indicated a desire to perform a training activity, at step 310 the training and evaluation platform determines a training activity for the first user. In certain embodiments, the platform may determine a particular training activity for the user to perform. Alternatively, the platform may present a number of training activities to the first user and prompt the first user to select a particular training activity to perform. In certain embodiments, the training activities may be determined based on one or more factors, including: input received from the first user and/or the first user's organization (e.g., higher level users), previous activities performed by the first user and/or one or more other users, feedback and/or reviews associated with the first user's performance in past activities, real-world data associated with the first user, and/or preferences provided by the first user. As discussed in more detail below, in certain of these embodiments, one or more training activities may be assigned or made accessible to the first user on a period basis, such as daily or weekly.

At step 320, the training and evaluation platform provides the first user with training activity data associated with the training activity that was determined for (and/or selected by) the first user. In certain embodiments, the first user may access the training activity data through a web-based training application, such as by viewing and interacting with the data and performing the training activity via one or more web pages and/or web applications. Alternatively, or additionally, some or all of the training activity data may be delivered to the first user (e.g., via e-mail, ftp, etc.), at one or more computing devices associated with the first user. In certain embodiments, the first user may also, or instead, access some or all of the training activity data from a third party website or service. For example, the training and evaluation server may enable (and/or provide the first user with information that allows) the first user to receive a simulated voice call from a third party provider.

In response to the first user accessing and interacting with the training activity data and performing the training activity, the training and evaluation server may then receive training response data from the first user. In certain embodiments, the first user may provide some or all of the training response data directly to the training and evaluation server, such as by inputting or selecting responses via web pages associated with the web-based training application. Similarly, the first user may input and/or select responses through a mobile application or stand-alone application on the first user's device, which may then (or at a later time) be sent to the training and evaluation platform. In certain other embodiments, some or all of the training response data may be received and/or accessed by the training and evaluation platform from various third party sources, such as a third party web server associated with making the training activity accessible to the users.

After the training and evaluation platform receives (or accesses) the training response data for the first user, at step 330 the first user's historical activity data may be updated based, at least in part, on the training response data. In certain embodiments, the first user's historical activity data may be updated to include an indication that the first user has completed the training activity and/or may store the some or all of the training response data. In certain of these embodiments, the training and evaluation platform may evaluate, rate, and/or score the first user's performance in the training activity, such as based on the training response data. For example, if the training activity is a multiple choice or true/false activity, the training and evaluation platform may determine a score based on the first user's answers and/or assign a point value to the first user's performance, which may be stored with (or used to update) the first user's historical activity data.

In addition to (or instead of) updating the first user's historical activity data, the training and evaluation platform may generate a collaborative review activity related to allowing other users to review and evaluate the first user's performance of the training activity. In certain embodiments, the collaborative review activity may be generated in response to receiving the training response data for the first user. For example, the training and evaluation server may generate and store a collaborative review activity that includes at least a portion of the training activity data and at least a portion of the training response data, such as to allow other users to view both the training activity performed by the first user and the first user's responses thereto. In certain other embodiments, the training and evaluation server may generate the collaborative review activity “on-the-fly”, such as when a request is received from another user to participate in a collaborative activity.

At step 340, the training and evaluation platform provides collaborative review activity data to a second user and receives collaborative review data associated with the second user performing the collaborative review activity. In certain of these embodiments, the training and evaluation platform may provide the collaborative review activity data to the second user in response to receiving a request from the second user to perform the activity. Alternatively, or in addition, the training and evaluation platform may assign the collaborative review activity to one or more users, including the second user, and/or notify the second user that there is a new collaborative review activity to be performed. In certain embodiments, the collaborative review data received in connection with the second user performing the collaborative review activity may include one or more ratings or scores and/or comments provided by the second user, pertaining to the first user's performance of the training activity.

At step 350, after the second user has performed the collaborative review activity (and/or during the activity), the training and evaluation platform may update the historical activity data associated with the first and/or second users. In certain embodiments, the historical activity data may be updated based on the collaborative review data received from the second user, such as in a similar manner to that described above in connection with updating the historical activity data based on the training response data. For example, the first user's historical activity data may be updated to include one or more scores and/or comments provided by the second user. As another example, one or more point values associated with the first user's performance of the training activity may be updated based on the scores provided by the second user. Likewise, the second user's historical activity data may be updated to indicate that the second user has performed the collaborative review activity, and/or to include the scores, ratings and comments provided by the second user.

In addition to (or instead of) updating the first and/or second users' historical activity data, the training and evaluation platform may generate a collaborative feedback activity related to allowing still other users to rate the second user's review of the first user's performance of the training activity. In certain embodiments, the collaborative feedback activity may be generated in a similar manner to the collaborative review activity described above. For example, in response to receiving the collaborative review data from the second user, the training and evaluation server may generate and store a collaborative feedback activity that includes at least a portion of the training activity data, at least a portion of the training response data, and/or at least a portion of the collaborative review data. In turn, this allows other users to view the training activity performed by the first user, the first user's responses thereto, and the scores, ratings and/or comments provided by the second user.

At step 360, the training and evaluation platform provides collaborative feedback activity data to a third user and receives collaborative feedback data associated with the third user performing the collaborative feedback activity. In certain embodiments, the collaborative feedback data received in connection with the third user performing the collaborative feedback activity may include one or more ratings or scores and/or feedback provided by the third user, pertaining to the second user's review of the first user, such as to indicate the usefulness or helpfulness of the second user's review. At step 370, after the third user has performed the collaborative feedback activity (and/or during the activity), the training and evaluation platform may update the historical activity data associated with the first, second and/or third users. In certain embodiments, the historical activity data may be updated based on the collaborative feedback data received from the third user, such as in a similar manner to that described above in connection with updating the historical activity data based on the collaborative review data. For example, one or more point values associated with the first user's performance of the training activity may be updated based on the ratings provided by the third user. Likewise, one or more point values associated with the second user's participation in the collaborative review activity may be updated based on the ratings provided by the third user. As another example, the third user's historical activity data may be updated to indicate that the third user has performed the collaborative feedback activity, and/or to include the ratings and feedback provided by the third user.

At step 380 the training and evaluation platform may receive a request from a user to access a leaderboard. In certain embodiments, such as where the training and evaluation platform utilizes gamification concepts (as described in more detail below), the platform may generate and/or make accessible one or more leaderboards to the users. In certain of these embodiments, the leaderboards may indicate the relative position or ranking of one or more of the users based on their performance and/or participation in training and/or collaborative activities, such as in connection with various scores or points awarded for each activity. For example, the training and evaluation platform may generate and/or make accessible a “global” leaderboard, which ranks the users based on a global score or point value associated with each user's participation and/or performance in activities through the platform over a specified period of time. As another example, the training and evaluation platform may generate and/or make accessible an activity leaderboard, which ranks the users based on a score or point value associated with each user's participation and/or performance in a particular activity. In certain embodiments, the training and evaluation platform may generate and store one or more leaderboards and/or update the leaderboards in response to users performing activities through the platform. In certain other embodiments, the training and evaluation platform may generate one or more of the leaderboards “on-the-fly,” such as in response to receiving requests from users to access the leaderboards.

For example, in response to receiving a request from a user to access the leaderboard, at step 390 the training and evaluation platform may determine ranking data for some or all of the users based on the updated historical activity data. In certain of these embodiments, the updated historical activity data may include one or more scores or point values associated with each user and the platform may determine the ranking data for the users based on summing each user's scores or points and/or applying one or more formulas or algorithms. In certain other embodiments, the training and evaluation platform may determine the ranking data for the users by calculating the scores or points that should be awarded to each user for their participation and/or performance in one or more training activities, such as based on the training response data, collaborative review data and/or collaborative feedback data associated with each user. In certain embodiments, after determining ranking data for the users, the training and evaluation platform may generate the leaderboard displaying the relative ranking of the users, and provide the leaderboard to a user in response to the request or make the leaderboard accessible to some or all of the users through the platform.

It should be understood that the order of the steps illustrated in FIG. 4 and described herein are merely exemplary and the order or combination in which various steps, such as updating historical activity data and determining ranking data, are performed may be modified or may be performed in any order or combination that is appropriate or desired by the organization and/or training and evaluation platform provider.

One advantage of the systems and methods described herein, as can be seen from FIGS. 1-4 and the corresponding description above, is the ability for employees and other users associated with an organization to access a training and evaluation platform and/or participate in training and collaborative activities over a network, without having to download and/or install any separate software on their user devices. Another advantage is that the training and evaluation platform can be accessed through virtually any type of Internet-enabled user devices, such as mobile devices. In turn, this allows the users to access the platform at any time from almost any location and participate in and perform various training and collaborative activities. As discussed above, this is particularly beneficial for organizations (e.g., sales), whose employees are often made up of a mobile workforce, because it allows them (as well as other types of users) to access and participate in the platform while they are traveling, out of the office, in-between meetings or on their commute to and from home. Thus, the described systems and methods facilitate and encourage participation in training and collaborative activities by making the platform and activities as easily accessible to users as possible through a wide range of devices and from virtually any location.

### Training and Collaborative Activities

The training and collaboration portion of the training and evaluation platform may include multiple different forms of training, teaching, testing, and collaboration. The training activities accessed through the platform can include any suitable type of training or learning activity that is designed to improve the users knowledge or ability in one or more areas or fields. In certain embodiments, the forms of training may include standard training and testing formats like multiple choice and text entry, either alone or in combination with other formats, such as simulation-based exercises and voice recordings. Similarly, the collaborative activities accessed through the platform can include any suitable type of collaborative activity that allows users to cooperate with and/or assist other users in training and/or real-world activities. In certain embodiments, the collaborative activities may include various forms of activities associated with reviewing other user's activities, rating other users' reviews, providing feedback and assistance to and receiving feedback and assistance from other users, and/or posting questions to or answering questions posted by other users.

Certain of these embodiments may capitalize on the features and functionality of modern smartphones, tablets, and other mobile and similar devices. For example, certain embodiments may utilize the multimedia capabilities of mobile phones and other handheld devices (e.g. speaker, microphone, camera, video) to allow users to listen to and/or view other users' responses to questions and scenarios and their performance in the training activities. Accordingly, this allows such users to rate and/or review the users' responses and to provide more effective and meaningful feedback. Also, as discussed above, the training and collaboration service and/or application may incorporate various third party software and services, such as through third party APIs, in order to provide additional features and functionality associated with training and collaborative activities.

In certain embodiments, the training activities and exercises offered to users through the training and collaboration application are based on a plug-in and/or modular format. Among other things, this allows new activities and training formats can be developed and easily added to the system as desired, such as by a particular organization. In a similar manner, the modular format simplifies and streamlines the process of updating, modifying, removing, and/or replacing existing activities as desired. In certain of these embodiments, the training and evaluation platform and/or training application may be configured to allow training modules to be added, updated and/or removed from the platform without needing to shut down the platform or take it offline.

For example, in certain embodiments, the training and collaboration application may include a number of training modules, which may include a combination of software, content and/or other data associated with training activities. Each training module may include, or be associated with, a number of training activities that can be made accessible to users through the training platform. In certain of these embodiments, each of the training modules corresponds to one or more particular types or formats of training activity and/or categories or areas of knowledge or skills to be trained. In turn, each of the training activities included within or associated with a training module may fit within one or more of the training formats or categories associated with that module. As a result, new training formats and categories of training content may easily be added to, modified, updated, replaced, or removed from the training and evaluation platform, by adding, modifying, updating, replacing, or removing one or more training modules. In certain of these embodiments, the training activities may be stored as pre-generated activities in a complete and fixed format which allows the platform to provide users with access to the training activities by simply retrieving the activity from the training module. In certain other embodiments, the training modules may store the training activities as a collection of training content and data, in which case, the training and evaluation platform and/or training application may be configured to generate the training activities, such as on-the-fly when requested by the users.

In certain of these embodiments, one or more of the training modules may be associated with a category of training that is based on the type of organization or the employees or users who are using the platform. For example, the categories may include information about the history or structure of the organization or its employees, owners, executives, etc., a product or service offered by the organization, one or more customers or clients of the organization, an area of business or experience associated with the organization, a skill or expertise required by the organization in general or for a position within the organization, or any other category of information associated with the organization, its business, and/or its activities. In certain embodiments, training modules associated with numerous different types and formats of training activities may be used, such as multiple-choice, true-false, short-answer, essay, audio simulation, video simulation, email simulation, and any other known format for training and learning. In certain embodiments, various other information may be stored or associated with the training modules and/or training activities. For example, each training activity may be associated with one or more standards or domains that are being trained (either directly or indirectly) through the activity, such as clarity, product knowledge, closing, communication, leadership, etc. In turn, these domains may be used by the evaluation application to track and analyze the users' proficiency across each domain. As another example, each of the training activities and/or modules may be associated with information indicating the type of review that is needed for the activities, such as whether the activity can be auto-scored (e.g., multiple choice) or auto-reviewed or whether the activity needs to be manually reviewed by other users (e.g., phone simulations).

In a preferred embodiment, the training and collaboration application has at least the following three types of training activities/modules: multiple-choice, text entry, and phone call simulation.

In certain embodiments, typical multiple-choice training activities may present the user with some content and a set of questions, along with potential answers to choose from for each question. The answers can optionally include both “all of the above” and “none of the above.” In certain embodiments, true-false questions may be included within the multiple-choice format. Alternatively, or in addition, training activities that include true/false questions may be associated with a separate true/false training activity format. In certain embodiments, results of the multiple-choice training activities are scored, graded, and/or judged by the training platform and/or application, preferably, automatically. In certain of these embodiments, the results may be provided to the users in real-time, such as at the end of the activity or after completing each question or group of questions. In certain embodiments, additional parameters can be associated with the multiple-choice activities, or individual questions within the activities as desired. For example, a multiple-choice training activity or one or more questions may be time-limited (i.e., once opening the question the user only has 2 minutes to answer). The questions may also be presented in a certain order, such as depending on their difficulty. In certain embodiments, the particular questions may be selected based on a user's role, prior experience and/or prior performance in the system, or input from other users (e.g., managers). In certain of these embodiments, the application may select or generate subsequent questions in the activity based on the user's responses to previous questions in the activity.

In certain embodiments, typical text entry training activities may present a user with some content along with a set of questions. The user may respond to the questions by providing a written response. In certain embodiments, the text entry may be in a short answer format and/or essay format. In certain embodiments, additional parameters can be associated with the text entry questions in a similar manner to that described in connection with the multiple-choice format above. Thus, like multiple-choice training activities, text entry questions may be time-limited. In certain embodiments, text entry questions may also, or alternatively, be subject to a word, page, or similar limit. In certain embodiments, other users may participate in collaborative activities associated with reviewing, grading, and/or judging the user's responses, such as based on their own experience or knowledge and/or on a particular set of criteria (e.g., one or more standards or domains). In a preferred embedment, other users may assign a certain score, for example, a point value from 0-5 and/or may provide constructive criticism, such as in the form of written feedback or comments. In certain embodiments, the user's responses to the text entry activity may only be reviewed by users associated with particular positions in the organization, e.g., supervisors, etc., and/or users associated with one or more user roles in the training and evaluation platform. In certain of these embodiments, one or more other users may be able to participate in a collaborative activity associated with grading or rating these reviews.

In certain embodiments, typical phone simulation training activities may present the user with a simulated phone call scenario, such as a simulated call with a customer or client. In certain of these embodiments, the user may be presented with certain content to read and/or listen to, such as background information associated with the simulated scenario. In certain of these embodiments, after the user has reviewed the scenario content, the user can select an option to continue to the phone simulation. In certain other embodiments, there may not be any pre-simulation content and/or the user may choose an option to proceed directly to the phone simulation part of the activity. The user may receive an incoming phone call at the user's device. In certain embodiments, the user may receive the phone call at the same device that is being used by the user to access the training platform. In certain other embodiments, the user may be given the option to select a device and/or phone number at which to receive the simulated phone call. In certain embodiments, the phone call may be initiated automatically by the platform or the third-party telephony service, such as within a predefined period after the user selects an option to proceed with the simulation. In certain other embodiments, the user may be given the option to select a particular day and time to receive the call or a time delay prior to receiving the call.

In certain embodiments, when the user answers the incoming simulated call, the user may hear one or more prompts or questions and can answer the prompts or questions using their own voice. In certain embodiments, the questions may be based on a stored recording or generated by a computer. In certain other embodiments, the prompts or questions may be provided by a live person, which enables a more interactive simulation. In certain embodiments, the prompts and questions and/or the user's responses may be recorded. In certain of these embodiments, such as where the simulated phone call is provided through a third-party service, the data associated with the recorded conversation may be provided to the training and evaluation platform, such as by transmitting the data to the training server or web server hosting and/or operating the platform and/or by storing the data in a database associated with a database server that is accessible by the training server or web server. Various additional parameters for the simulated phone call training activity can be set in a similar manner to that described in connection with multiple-choice training activities above. Thus, like multiple-choice training activities, phone simulation activities (or one or more responses therein) may be time-limited. In certain embodiments, the amount of time the user has can be set per training activity. In a preferred embedment, once the user is finished with the phone simulation training activity (such as by time running out and/or by the user hanging up the phone), one or more collaborative activities may be generated or be made accessible to other users, in which the other users may listen to the prompts or questions and/or the user's responses and review the user's performance in a similar manner to that described in connection with the text entry training activities. In turn, additional collaborative activities may be generated and/or made available to certain users that pertain to rating or grading the reviews.

In certain of these embodiments, phone simulation training activities and other forms of simulation-based training activities (e.g., video simulations) may utilize software and services provided by a third party service provider, such as through a third-party API. For example, various a third party telephony APIs and services exist that allow developers to create and modify their own software applications to initiate a phone call from one phone or device to any other phone or device in the world. There are a number of providers in this space, such as Twilio Inc., a provider of a preferred third party telephony API, which can be utilized in the phone response question activities of the present invention. In certain embodiments, various other forms of simulation and/or interactive training activities may be provided through the training and evaluation platform, such as fax simulations, e-mail and instant message simulations, and live simulations.

In addition to, or instead of, one or more of the above identified training activity formats, users may participate in other types of activities as requested, desired, or as allowed by their employer or organization or the party operating the training and evaluation platform. For example, one such activity may be a Question & Answer message board or forum. In certain embodiments, only certain users, depending on their status or role in the system and/or their position in the organization, may post and/or answer questions through the message board or forum. In certain other embodiments, the ability to post questions may be restricted while the ability to answer the posted questions may be open to all users. For example, certain users may post questions and/or answers to the Questions & Answers board that are related to a variety of topics or activities, e.g., either answering or posting a question of the week or day. In certain of these embodiments, the training and evaluation platform may automatically generate a question of the day or week, etc., on a continual basis, such as to promote further discussion on a particular topic or activity. In certain embodiments, the questions may be associated with activities provided through the platform and/or real-world tasks or activities pertaining to the user's organization In certain embodiments, users can rate or grade one or more particular answers to a question. In certain embodiments, the mobile web application may also allow users to flag or bookmark certain questions and/or answers, such as in a “favorites” list, such as in order to be able to quickly access and view all of the questions and/or answers they marked as important or helpful.

In certain embodiments, the training modules and/or activities that are made available to the users through the platform may be selected, created, updated, and/or customized based on the particular organization or company, industry associated with the organization, and/or the group of users participating in the platform. In certain of these embodiments various categories of training content e.g., customer information, product or service information, required skills, compliance, company policies, field of expertise, one or more domains etc., and/or training formats, e.g., video simulation, essay answers, true-false, etc., may be created and/or customized for a particular organization. In certain embodiments, the organization may be able to create and/or customize the training modules and activities and/or allow a third party to do so on its behalf. In certain of these embodiments, the training modules and/or activities may be created and/or customized, as well as tested, using a separate instance of the platform that is provided for testing and development purposes, prior to being included in a live instance of the platform.

As discussed in further detail below, the training modules and/or activities made accessible through the training and collaboration application may focus on a particular area, topic, skill, or the like for a specified period, such as each week or month, etc. In certain of these embodiments, the application may suggest training activities to one or more users that are designed to improve and train the area, topic, or skill being targeted during that period. In certain of these embodiments, such as where the application is configured to generate the training activities on-the-fly, particular content, questions, training modules and/or activities may be selected based on a user's or a group of user's previous performance on that area, topic, skill, etc. and/or may utilize the “didactic” concept for learning, i.e., returning to previously taught principles/skills in order to promote reinforcement.

In certain embodiments the training and evaluation platform allows users to participate in a wide range of collaborative activities in addition to the training activities offered through the platform. In certain of these embodiments, such as in connection with the group-based and/or gamified training environments discussed below, the platform may be configured to encourage and/or incentivize participation in collaborative activities in order to create and promote a collaborative training environment in which users cooperate with and assist each other to improve their knowledge and skills. In turn this leads to a number of benefits to the users and the organization, such as increasing the overall effectiveness and quality of the training environment, as well as the skills, knowledge, and capabilities of the users (e.g., work-force).

In certain embodiments, some or all of the collaborative activities made accessible through the training and evaluation platform may be based on, or associated with (either directly or indirectly), the participation and performance by users of training activities through the platform. For example, as referenced throughout this disclosure, the users may be able to participate in various types of collaborative activities that are associated with reviewing a user's performance of a particular training activity, such as a text entry or phone simulation training activity. As another example, the users (or certain types of users) may be able to participate in collaborative activities associated with providing feedback in connection with the reviews provided by other users, such as by grading or rating the usefulness or quality of the other users' reviews. As yet another example, the users may be able to participate in collaborative activities associated with posting questions for other users to answer and/or or answering questions posted by other users (e.g., through the Question and Answer message board), as well as rating or ranking other users' answers to the questions. In certain embodiments, one or more other types of collaborative activities (i.e., collaborative activities that are not review-based) may also, or alternatively, be made accessible to the users through the platform. For example, these collaborative activities may include the users working together on group presentations or classes to present to other users through the platform and/or participating in group projects and/or team-building exercises.

According to certain embodiments, the training and evaluation platform may generate collaborative activities in response to users participating and/or completing training and other collaborative activities. For example, when a user completes a short answer training activity, the training platform and/or application may store certain information associated with the user's participation in the activity, such as by updating user tracking data to include an indication that the user completed the short answer training activity and/or the user's responses to the short answer questions. A collaborative activity associated with reviewing and/or grading the user's performance in the short answer training activity may then be generated and made accessible to some or all of the other users of the platform. In certain embodiments, the collaborative activity may prompt users to provide various scores associated with one or more aspects of the user's performance of the training activity and or text-based or other types of feedback. In certain of these embodiments, the scores may correspond to one or more skills, domains or standards (e.g., clarity, communication, leadership, etc.) associated with the training activity. For example, the user may be asked to grade the user's performance in each skill or domain, such as by inputting or selecting a number from a predefined range (e.g., 1 to 10).

In certain embodiments, the collaborative activity may be generated by creating a separate object or similar structure for the collaborative activity, which may contain all of the data needed to present the collaborative activity to users, including a copy of the questions asked and responses provided by the user that performed the training activity. In this manner, the data can be easily accessed, retrieved and presented to a user in response to the user requesting to participate in the collaborative activity.

In certain other embodiments, the collaborative activity may, instead, be generated by storing a reference to the collaborative activity, such as in a global database, list or similar structure, associated with the currently available collaborative activities, or storing a reference or indicator together with the user data and/or user tracking data associated with the user who performed the training activity. In certain of these embodiments, the reference may simply include an identifier for the user and/or an identifier for the training activity. This reference may allow the platform and/or application to lookup and/or retrieve the relevant data and build the collaborative activity on-the-fly in response to a request from a user to participate in the collaborative activity. In certain embodiments, the collaborative activity (or reference thereto) may be automatically generated each time a user completes a training or collaborative activity. In certain other embodiments, collaborative activities (or references thereto) may only be automatically generated for certain types of training activities (e.g., simulation, short answer). In yet other embodiments, the user performing the training activity may be able to choose whether or not to receive reviews or feedback from other users through collaborative activities.

Along with the collaborative activities pertaining to reviewing a user's performance of a training activity, collaborative activities associated with providing feedback concerning the user reviews of training performance (e.g., rating the review and/or providing comments) may also be generated and made accessible to users in a similar manner. For example, in response to a second user completing a collaborative activity and reviewing a first user's training performance, the platform and/or application may generate a “second tier” collaborative activity that allows a third user to rate the second user's review. In certain of these embodiments, the second tier collaborative activity may prompt the third user to provide one or more scores for the review and/or text-based or other types of feedback associated with the review. In certain embodiments, the second tier collaborative activity may allow the third user to modify and/or remove the second user's review, such as to adjust the review for accuracy or helpfulness by changing one or more scores assigned and/or editing the textual comments provided by the second user. In certain embodiments, the collaborative activity may be streamlined, such as to simply request the user to select a rating from a number of predefined rating options, e.g., helpful, unhelpful, neutral, etc. According to certain embodiments, the second tier collaborative activity may allow the user to access and/or view the original training activity and the responses from the first user, as well as the second user's review of the first user's performance. An important benefit of these second tier collaborative activities is that they allow an organization (e.g., high-level employees or managers) to control and adjust how its employees use the training and evaluation platform, such as to refine how reviews and feedback are performed and delivered through the platform.

In addition, various other types of collaborative activities may also be generated and performed in a similar manner to the collaborative activities described above, such as collaborative activities associated with answering and/or reviewing answers to questions posted on a message board or forum. An important benefit of the collaborative process described above is that it improves the effectiveness and quality of the reviews and feedback provided through the platform. Another benefit is the ability for users of the platform to receive meaningful feedback and reviews from a range of other users associated with the organization, such as the user's peers and supervisors.

### User Roles

According to certain embodiments, the users associated with the training and evaluation platform may be assigned a user role. For example, an indication of the user role associated with each of the users may be included in the user data, which may be stored at and retrieved from (e.g., when the user logs in to the platform) a database server, such as in a similar manner to that described in connection with FIGS. 1 and 2. In certain of these embodiments, the user roles associated with each user may be selected from a predefined set of possible user roles, such as user roles that are based on and/or customized by an organization.

In certain embodiments, the user roles for each user may be based (in whole, or in part) on the user's role within the organization or company. For example, the user roles may include: new-hires, associates, senior associates, partners, assistant managers, managers, regional managers, and global managers, or virtually any suitable type of user role associated with one or more positions or titles within an organization. In certain other embodiments, the user roles may be more generic in nature, such as participant, coach, leader, etc., which may loosely correspond to certain levels or categories of employees of a company or other types of users. In yet other embodiments, the user role may be separate from the users' real-world positions. In certain of these embodiments, the users may advance up (or move down) through the user roles, such as based on their real-world advancement and/or their participation and/or performance in the training and collaborative activities through the platform.

According to certain embodiments, the user roles associated with each of the users may be utilized by the training and evaluation platform in a number of different ways. For example, in certain embodiments, certain portions of the platform (e.g., the evaluation application) may be restricted to users associated with certain types of user roles. Similarly, access to certain types of collaborative activities, such as second-tier collaborative activities (e.g., rating a user's review of another user's training performance), may be limited to certain user roles. As another example, the platform and/or training application may determine, generate, and/or customize different types of training activities and collaborative activities for different groups of users based on their user roles. As yet another example, the user roles may be utilized in connection with the evaluation application, such as to analyze the performance of the users associated with a particular user role and/or search within one or more user roles for “star” employees or possible rising leaders.

In certain embodiments, such as where the training and evaluation platform and/or training and collaboration application is provided in the form of multiple instances of the platform, the user roles may be utilized in determining how to divide the users across the different instances of the platform. For example, in certain of these embodiments, each instance of the platform may be required to have a specified number or minimum or maximum number of users associated with a particular user role (e.g., at least 5 managers in each instance). Another option may be to have a target ratio based on two or more of the user roles (e.g., at least one manager for every 10 players). This provides the ability to maximize the likelihood that each the different instances will have a balanced group of users. In certain embodiments, users associated with one or more of the user roles (e.g., managers or high-level user roles) may be able to access a number or all of the separate instances of the platform, such as to monitor the progress of, and interact with, the users in each platform.

The following provides an example of a training and evaluation platform according to one embodiment, in which the different roles associated with the users of the platform are: Player, Captain, Coach, and Manager:
Player—a Player may be a standard user of the platform, such as an employee, contractor or other user associated with an organization, with no special abilities like those associated with Captains, Coaches, or Managers;
Captain—a Captain may be allowed to post questions to the Question & Answer message board and rate other user's collaborative reviews of training performance. Captains may also be allowed to give special “awards” to other users (e.g., Players) that can be displayed next to their name and presented through the platform, such as on a leaderboard (discussed below);
Coach—a Coach can do everything Captains can do, but their points are not shown on the leaderboard. For example, Coaches may be focused on overseeing the platform and/or providing ratings and feedback, posting questions of the day, etc. In the case where there are multiple instances of the platform, Coaches may be able to access some or all of the separate instances; and
Manager—a Manager is like a Coach, but may also be able to log into the evaluation platform or application, such as a Manager Dashboard (described in further detail below).

Although four specific user roles have been described in the example above, it should be understood that the training and evaluation platform and/or training and collaboration application may include any number and/or type of user roles, which may be associated with various tasks, functionalities, access-privileges, and other like features and abilities, such as may be desired by a particular organization. As shown in the foregoing discussion, the use of user roles provides a tiered approach to evaluating, educating, training, and/or reviewing users of the platform. In this regard, users are able receive meaningful feedback associated with their activities and exercises in a timely manner from various other users, including Captains, Coaches, and Managers.

### Group-Based and Gamified Training Concepts

According to certain embodiments, the training and evaluation platform may utilize group training concepts to increase the effectiveness of the training and collaborative process. In certain of these embodiments, one or more training or collaborative exercises may be recommended and/or assigned to a group of users through the training and evaluation platform. The selected or identified group training activity may be recommended and/or assigned (e.g., made available) to all of the users of the platform or a subset of the users, such as users associated with a particular user role, users determined to have a need for such training, or users identified by the organization or certain high-level users (e.g., Coaches or Managers). In certain of these embodiments, such as where the platform is implemented as a number of separate instances, the group training activity may be recommended and/or assigned to users across multiple instances of the platform.

In certain embodiments, the recommended activities may be selected by or based on input from the organization, certain employees associated with the organization, and/or users of the platform associated with a particular user role (e.g., Coaches or Managers). For example, a Manager or individual associated with the organization may determine that there is a general need for training in a particular area, such as based on real-world data associated with the users and/or analytics or reports obtained through the evaluation portion of the training and evaluation platform (as discussed in more detail below). In addition, or as an alternative, the platform may be configured to automatically recommend and/or assign training and collaborative activities to users. For example, the platform may determine a recommended training activity for one or more users based on a number of factors, such as the users' performance on prior training activities (e.g., scores on multiple choice tests), performance reviews provided by other users, the users' roles, the type of user (e.g., all new employees are assigned certain training activities), and/or a general training syllabus or schedule set by the organization.

In accordance with certain embodiments, the training and evaluation platform may be configured to automatically determine group training activities to recommend and/or assign to all or a group of the users on a periodic, recurring basis, such as daily, weekly, or monthly. In certain other embodiments, the group training activities may be deployed sporadically or on an as-needed basis, such as in response to input from the organization or certain users (e.g., Coaches or Managers). In certain embodiments, all of the training activities made available through the training and evaluation platform may be in the form of group training activities. In certain other embodiments, the group training activities may be used in combination with other training activities, such as training activities recommended or assigned to specific users or general training activities made available to all of the users through the platform.

As can be seen from the disclosure herein, there are a number of advantages associated with the utilization of group training concepts within the training and evaluation platform. One important benefit is the ability to promote meaningful collaboration and sharing of knowledge and experience amongst a group of users, such as an organization's workforce, which translates into more effective training and, in turn, a more skilled and efficient workforce. For example, as discussed in more detail below, through the incorporation of group training concepts, users can review and comment on other users responses, answers, or overall statistics and/or post and respond to questions regarding the training activities or real-world issues, which improves the knowledge and skills of both the reviewer and the reviewee. Another important benefit is that group training encourages competition amongst the users and brings accountability to the forefront, thereby further motivating users to engage in regular and consistent training and collaborative activities through the platform. For example, assigning the same training and collaborative activities to a group of users allows the users to compare their performance on certain activities and/or monitor their general progress and participation in the training and evaluation platform relative to other users.

In addition, or as an alternative, to group training, in certain embodiments, the training and evaluation platform may utilize various game based training concepts. Certain of these embodiments combine user autonomy and user interaction with common game concepts, such as scoring, point tracking, leaderboards, and awards (e.g., prestige, prizes, and/or financial incentives). For example, the training and evaluation platform may incorporate the idea of “gamification” in order to present the training platform as an interactive, addictive, and challenging game-based training environment. Like group training, one significant advantage to the use of gamification is that it significantly encourages user participation. These gamified training concepts make training more engaging and promote regular participation in activities through the platform by taking advantage of a humans' psychological predisposition to engage in competitive activities. Another advantage is that certain gamification concepts enable an organization to motivate users to engage in certain desired types or categories of training and collaboration (e.g., to master a particular topic, skill, or concept) and to easily update the area of training or collaboration on which to focus, such as in response to evaluations and results associated with activities performed through the platform and/or real-world activities.

In certain embodiments, such as where gamification concepts are utilized, most or all of the training may be in the form of group training. For example, users may complete periodically assigned training activities, judge other users' responses to and performance in these assigned activities, and participate in various interactive discussions, such as forums and Question & Answer boards. According to certain embodiments, the training and evaluation platform may determine, select and/or generate one or more training activities for all of the users or for one or more groups of users on a periodic basis, such as daily, weekly, or monthly. These training activities may be assigned to and made accessible to the users through the platform and, at the end of each specified period, the platform may determine a new set of training activities for the users.

In certain of these embodiments, the assigned activities may only be accessible to the users for a limited time, such as during the specified period. One advantage to having the training activities expire after a certain amount of time is that it motivates users to access and participate in activities through the platform on a regular basis, and deters users from performing all of their training in bursts on a sporadic basis (e.g., cramming their all of the training into one day each month). In certain other embodiments, the training activities may continue to be accessible to users through the platform after the specified period, such as until they perform the activities or for a predetermined period (e.g., one month).

In certain embodiments users may be awarded a score or points for participating in, performing and/or completing various activities or tasks through the training and evaluation platform. For example, a certain number of points may be awarded to users for participating in or completing training activities, such as training activities assigned to the users for a specified period. In certain of these embodiments, the points may be awarded and/or updated based on a user's performance in the training activity (e.g., based on determining the user's score on a test). In a similar manner, according to certain embodiments, the points may be awarded and/or updated based on other users' participation in collaborative activities related to the user's performance in the training activity (e.g., based on another user's review of the user's responses to a short answer or voice response training exercise).

As another example, a certain number of points may be awarded to users for participating in or completing collaborative activities. In certain of these embodiments, the points may be awarded and/or updated based on other users' evaluations of the user's participation in the collaborative activity (e.g., based on another user's rating of the user's responses and/or comments). As yet another example, a certain number of points may be awarded to users for engaging in other activities through the platform, such as posting questions to a Question & Answer board, responding to questions posted by other users, reviewing or rating other users' responses to the questions, and/or posting or answering a question-of-the-day. In certain of these embodiments, users may also be awarded points for activities outside of the training and evaluation platform, such as their performance in real-world tasks.

The following describes an exemplary series of activities participated in by users through the training and evaluation platform, along with the points awarded to the users for such activities. In response to a first user completing a voice response training activity (e.g., a simulated sales call), the first user may be awarded five points. Subsequently, a second user may participate in a collaborative activity associated with reviewing the first user's responses to and/or performance in the simulated sales call. The second user may be awarded five points for completing the review. Also, if the second user's review is favorable (e.g., the second user gives high scores or ratings to the first user's performance), then the first user may be awarded three additional points (e.g., by updating the first user's score to a point value of eight). In contrast, if the second user's review is unfavorable, three points may be subtracted from the first user's score (e.g., by updating the first user's score to a point value of two). Similarly, a third user may participate in a second type of collaborative activity associated with providing feedback in connection with the second user's review of the first user's performance (e.g., rating the usefulness of the second user's reviews, scores, and/or comments) and may be awarded five points for completing the collaborative activity. In turn, the points awarded to the second user may be updated based on whether the rating provided by the third user is positive or negative. The foregoing example is provided solely for purposes of describing one manner of awarding points to users according to certain embodiments, and it should be understood that any number or type of points or scores may be awarded for users' participation in, completion, and/or performance in various activities, tasks, or actions through the platform.

In certain of these embodiments, the points or scores that are assigned and/or awarded to users through the training and evaluation platform may be weighted. The points may be weighted on a number of different factors, such as the type of activity (e.g., training or collaboration), the form of training activity, the category or subject matter associated with the training activity, or any other suitable factor. One important benefit associated with assigning different weights to the point awards is that it allows an organization to focus its users on participating in a particular type or category of activities and easily adjust the focus on a periodic basis as desired. For example, in certain embodiments, the points awarded for participating in or completing training activities associated with a specific skill set or area of expertise may be weighed more heavily in order to encourage users to focus on improving these skills. In certain of these embodiments the weights associated with particular training activities, may be increased or decreased in response to determinations concerning the needs of an individual user or a group of users, such as in response to evaluations of the users' prior performance in training activities through the platform. The weights may also, or alternatively, be increased or decreased based on the users' performance and success in real-world tasks.

Another significant benefit associated with such weighting of point awards is the ability to encourage collaboration amongst the users. For example, in certain embodiments, the training and evaluation platform may award two points to a user for completing a particular training activity, while awarding four points to users who complete a collaborative activity pertaining to reviewing and/or rating the first user's performance in and responses to the training activity. Similarly, the platform may assign a higher weight to the points awarded for users responding to questions posted to a forum or message board by other users. In turn, weighting collaborative activities more heavily motivates users to review the training activities of other users, which can improve the skills of both the reviewer and the person being reviewed, and promotes a collaborative training environment amongst the users of the platform. By allowing an organization to modify the scores, points, and/or weights associated with various training, collaborative and other activities, the training and evaluation platform provides a highly customizable and responsive scoring mechanism that can be continuously adjusted to fit the strategic needs of the organization.

In certain embodiments the points awarded to users through the training and evaluation platform may be associated with a single type or category of points, such as a general point category. Alternatively, or in addition to the general point category, the platform may award a number of different types of points or scores to users or may associate the points awarded to users with certain point categories, such as based on the particular activities participated in or performed by the users. For example, users may be awarded training points for participating in and completing training activities and collaboration points for participating in and completing collaborative activities. As another example, the points awarded to users may be categorized based on the format or type of content associated with the training activities. As yet another example, the points may be classified based on the types of skills or domains (e.g., leadership, communication, etc.) associated with the activity. In certain of these embodiments, the points awarded for each training activity may be broken down based on the users' performance and/or score for each skill or domain being targeted through the training activity.

In certain of these embodiments, the training and evaluation platform may determine the point values to assign or award to a user for the user's participation in and/or performance of an activity, task, or action through the platform based on stored point data. For example, the stored point data may include data that enables the platform to determine one or more point values to award users in connection with various activities, tasks or actions, such as minimum point values, maximum point values, point weights, point categories, and/or point scales or ranges associated with each activity, task or action. In certain embodiments, the point data may include various formulas or algorithms that allow the platform to determine the points that should be awarded and/or updated for various activities, tasks or actions. In certain of these embodiments, the point data for each activity may be stored with the training data associated with the activity.

In certain embodiments, the points assigned or awarded to users may be stored by the training and evaluation platform, such as with user data and/or tracking data maintained at a database server associated with the platform (e.g., database server 20 illustrated in FIG. 1). In certain of these embodiments, the platform may store and/or update one or more point values associated with each user in response to the users participating in or performing activities, tasks or actions through the training and evaluation platform. For example, the platform may store and/or update one or more point categories (e.g., general points, training points, leadership points) in user data associate with a user in response to the user completing a training or collaborative activity. In certain embodiments, the platform may also, or instead, store and/or update the points awarded for each activity, task, or action participated in or performed by a user, such as by storing one or more point values with the tracking data associated with the user. In certain other embodiments, rather than storing or updating one or more point values at the time an activity, task or action is participated in or preformed by a user, the platform may simply store and/or update the tracking data associated with the user to reflect the user's participation or performance and utilize such tracking data at a later time to determine the point values for the user.

According to certain embodiments, the training and evaluation platform may determine one or more scores for some or all of the users, such as a global score for each user based on the points awarded to the user. In certain of these embodiments, such as where the platform assigns multiple categories of points to the users, the platform may determine scores associated with some or all of the point categories (e.g., a collaboration score, a participation score, a leadership score, a communications score). The scores may be determined by the platform in any suitable manner. For example, the platform may determine one or more of the scores by retrieving point values associated with the users (e.g., point values stored with the user data that are updated by the platform in response to activities, tasks and actions being participated in or performed by the users).

As another example, the platform may determine one or more of the scores based on point values stored for each activity, task or action (e.g., point values stored with the tracking data for each user), such as by adding the stored point values associated each activity, task and action participated in or performed by a user. As yet another example, the platform may determine one or more of the scores by utilizing the tracking data associated with each user to identify the activities, tasks and actions participated in or performed by a user and calculate the point values that should be awarded or assigned for such activities, task and actions. In certain of these embodiments, the platform may use one or more algorithms in order to determine the scores, such as algorithms that take into account the weights for one or more types or categories of points awarded to a user. In certain embodiments, the training and evaluation platform may store and/or update one or more of the scores, such as in ranking data associated with each user. In certain other embodiments, the ranking data may be determined on-the-fly, as needed by the platform.

The points and/or scores associated with the users may be utilized by the training and evaluation platform in various ways, such as to encourage regular and consistent user participation in training and collaborative activities. In certain embodiments, one or more of the point values or scores associated with the users may be made available to some or all of the users through the platform. In certain of these embodiments, the training and evaluation platform may generate one more leaderboards or the like that includes some or all of the users in an order or format based on one or more of the scores associated with such users, and display the leaderboard to the users through the platform. For example, the platform may generate and make available a global leaderboard that lists each user in descending order based on each user's global score. In certain of these embodiments, some or all of the leaderboards may be updated in real-time or may be updated when accessed by a user through the platform. One significant benefit associated with displaying such leaderboards to users and/or making the users scores or points accessible to other users is that it increases user accountability and drives competition amongst the users by allowing users to view and track their scores relative to other users.

In certain embodiments, the training and evaluation platform may generate a number of leaderboards and/or allow users to filter one or more leaderboards based on various parameters. For example, the leaderboards may be created and/or filtered based on a type or category of points, a type of activity, task, or action, a format or category of training, a skill or domain, and/or a period of time. As another example, the platform may generate separate leaderboards for the users associated with each of the user roles. In certain of these embodiments, one or more of the leaderboards may be made accessible to a limited group of users (e.g., the users associated with a particular user role). In certain embodiments, such as where the training and evaluation platform is provided through multiple instances, one or more of the leaderboards may be generated separately for each instance or may include users from some or all of the instances of the platform. In certain other embodiments, users may be able to search through and/or apply filters to one or more of the leaderboards, such as to search for a particular user or filter the user by user role.

According to certain embodiments, one or more of the scores associated with the users may be in the form of a rolling tally. In other words, the scores may be based on the points assigned or awarded to each user and/or the activities, tasks and action participated in or performed by each user over a limited period, such as the preceding week, month, year, etc. For example, a global score associated with each user may be based on the points accumulated by the user through participating in and performing training and collaborative activities and/or other actions over the last month. In turn, the global scores may be updated each day to discount any points awarded for activities, tasks or actions that occurred prior to the last month and factor in any newly awarded points (e.g., points awarded for activities, tasks, or actions participated in or performed that day or the day before). In certain embodiments, instead of (or in addition to) limiting the scores to a specified period, the platform may generate and make available to the users one or more leaderboards or the like that rank the users based on the points assigned or awarded to each user for the specified preceding period.

There are a number of advantages associated with determining and displaying one or more of the scores as a constantly rolling tally. One such advantage is that, because users' points may decrease after a certain period of inactivity, users are motivated to consistently access and use the training and evaluation platform and participate in regular training and collaborative activities and other tasks or actions, rather than engage in sporadic instances of high activity followed by low or no activity (e.g., cramming). Another advantage is that the use of rolling tallies provides newer users with a more meaningful representation of their scores relative to other users by effectively placing each user on a level playing field based on the specified period.

In certain embodiments, the points and/or scores associated with the users may be utilized by the training and evaluation platform for other purposes, such as to enable users to view and/or monitor their participation in or performance of a particular activity, task or action (or group of activities, tasks or actions) relative to other users. For example, in response to a user completing a training activity, the platform may generate and make accessible to the user a leaderboard or the like that displays the user's points or scores for the training activity relative to the points or scores associated with one or more other users who have previously performed the same training activity. In certain of these embodiments, the platform may update the leaderboard (e.g., when the user subsequently accesses data associated with the performed training activity), such as to take into account updated point values for the user based on reviews provided by other users and/or to update the relative ranking of the user in response to other users performing the training activity.

In certain embodiments, the points and/or scores associated with the users may be utilized by an evaluation portion of the training and evaluation platform, such as to allow an organization or certain authorized users (e.g., based on a particular user role) to analyze, evaluate and/or identify one or more users. For example, the organization or authorized users may access an evaluation application to view the users who have accumulated the highest (or lowest) number of points and/or have the highest (or lowest) scores, such as to identify key employees or underperforming employees and/or to determine one or more skills or areas for which certain users may need additional training.

According to certain embodiments, the points and/or scores associated with the users may be utilized as a mechanism to offer a combination of rewards and/or punishments, such as to allow an organization to induce or deter behavior with little or no cost. For example, in certain of these embodiments, the points and/or scores may be used to award certain users (e.g., those with the highest scores) with various monetary and/or non-monetary items, such as a promotion within the organization or within the platform (e.g., assigned to a higher-level user role) or a year-end bonus. As a result, organizations may incentivize and reward the users having significant levels of participation and performance in the training and evaluation platform, thereby further encouraging regular and consistent user participation in activities through the platform.

### User Evaluation and Analysis

In certain embodiments, the training and evaluation platform may include an evaluation application, such as a “Manager Dashboard,” which provides employers or other organizations associated with the platform with the ability to track and analyze user activity in the platform in order to obtain a comprehensive view of how each user utilizes the training application, interacts with other users, and participates and performs in training, collaborative, and other activities through the platform. In certain of these embodiments, some or all of the features and functionality associated with user tracking and analysis may be incorporated within the training application (i.e., the application used to access the training and collaborative activities), such as another section of the mobile web application hosted by the training server in FIG. 1.

In other embodiments, some or all of these features and functionality may be provided through a separate evaluation application, such as in the form of a stand-alone client application, a web application and/or a mobile application designed for use with smartphones, PDAs, desktops, laptops, and/or tablets. In certain of these embodiments, the evaluation application may be hosted and operated by the training server, or may be hosted and operated by a separate server, such as the evaluation server illustrated in FIG. 1. The evaluation server may then interface with the training server and/or one or more database servers and database (see FIGS. 1 and 3) used by the training server, in order to access information stored in connection with the training, collaborative and other activities participate in and performed by users through the training application.

In certain embodiments, access to the evaluation application may be restricted to certain individuals. For example, the evaluation platform may be restricted to high-level employees authorized by the company or organization, such as managers, supervisors, officers, etc. As another example, the evaluation application may be restricted to users having a particular user role (e.g., coaches, managers). In certain embodiments, access to the evaluation application may also, or alternatively, be limited to one or more computers and/or networks. As illustrated in FIGS. 1-3, for example, a manager, supervisor, or other high-level employee may be required to access the application from a workstation or company computer that is connected to the evaluation server through a local network.

The features and functionalities associated with the evaluation application provide novel ways for companies and organizations to evaluate their employees by viewing and tracking statistics and trends of the users participating in the training platform. In certain embodiments, the evaluation application may be configured to access and utilize user tracking data that is stored by the training and evaluation platform and includes information associated with each user's participation and performance in the platform, such as the activities performed, results for each activity, reviews, feedback, scores, points, etc. In turn, this allows the company and/or high-level employees to quickly and easily analyze various aspects of the users' participation and performance in the platform, such as the users' overall performance in training activities.

In certain of these embodiments, the evaluation application may enable the company and/or high-level employees to evaluate and track particular aspects of user performance and/or participation, such as by inputting and selecting various performance criteria. For example, the evaluation application may allow the selection of a subset of users (e.g., users having a particular user role or position in the company, new-hires, temporary employees, etc.) and/or an individual user to evaluate. As another example, authorized employees may be able to select one or more skills or domains (e.g., leadership, communication, product knowledge) for which to evaluate the users' performance. Similarly, users may be evaluated based on various other types of criteria, such as categories or areas of knowledge, level of participation in collaborative activities, quality of peer-reviews, frequency of use of the platform, etc. In certain of these embodiments, the company may be given the option to save a particular set of performance criteria to be used again in the future.

In certain embodiments, the evaluation application may generate various reports which provide various information related to the performance and participation of the users in the platform. In certain of these embodiments, for example, the evaluation platform may periodically generate one or more high-level reports that include certain information about each of the users, such as overall performance, performance in one or more domains, participation in collaborative activities, etc. Similarly, the evaluation platform may allow companies and/or high-level employees to generate reports based on the analysis associated with selecting and inputting various performance criteria. In certain embodiments, the evaluation application may also be designed to automatically track some or all of the users based on a particular set of performance criteria (e.g., to identify any users whose overall participation drops below a certain amount or whose performance in a specified domain falls below a certain level) and/or generate periodic reports based on such criteria.

The ability to track, analyze, and evaluate the users of the platform and drill down into a particular area, such as a group of users or a type of skill, provides employers and organizations with a number of significant benefits. One such benefit is that it enables employers to identify skills, domains, and/or areas of knowledge for which one or more users may need additional training. For example, by using the evaluation application, an employer may discover that a user or group of users have exhibited weak performance in particular domain, such as communication. In turn, the employer may update the training application to provide additional training activities that are designed to improve communication. Alternatively, or in addition, the employer may encourage the identified users to participate in and focus on these type of training activities, such as by assigning communication-based training activities to the users on a periodic basis and/or increasing the points awarded (or the weight of the points) for completing such activities. In certain embodiments, the evaluation platform may be designed to automatically identify users that need training in a particular area and/or modify the training application accordingly. As a result, the evaluation application enables employers to react to certain weaknesses and/or training needs of their employees and adapt the training platform on a continual basis.

Another benefit is that employers can utilize the evaluation application to evaluate and identify certain types of users in order to facilitate real-world decisions, such as advancement, termination, placement, etc. For example, the evaluation application may be used to identify star employees or employees that may be suited for a particular role or position in the company (e.g., management), such as by identifying the users with the top performance and/or scores in leadership and communication and highest levels of collaboration and assistance to other users through the platform. In a similar manner, companies may use the evaluation platform to identify weak or underperforming employees that should be demoted, terminated or placed in a different position. As another example, the evaluation platform can be used to evaluate the performance of potential new employees, temporary employees, and/or employees who are new to a particular position. In turn, this information can be used to assess the capabilities of such employees over a trial period and/or to determine whether or not to hire such employees on a permanent basis.

Yet another benefit is that employers and others (such as the parties who are providing and/or hosting the platform and/or creating the training activities) can use the evaluation platform to evaluate the effectiveness, attractiveness, and/or value of certain training activities or portions thereof. For example, after incorporating a new training activity into the training and evaluation platform, the evaluation application may allow employers to analyze whether the training activity was successful overall and/or effective in the intended training areas or categories, such as by tracking whether the users who have completed the training activity show improvement in the relevant skills. In certain embodiments, such as where the training activity includes a number of questions, the evaluation application may be used to evaluate a question or a group of questions, such as to determine a level for each question (e.g., easy, medium, hard). Likewise, the evaluation platform can be used to identify types or formats of training activities that best encourage user participation in the platform, such as by tracking the training activities that are completed by the highest percentage of users. In certain embodiments, the evaluation application may be used to evaluate other types of activities and tasks, such as collaborative activities, in a similar manner.

In certain embodiments, such as where the users are separated across multiple instances of the training application, the evaluation platform may be used to analyze and track the relative performance and effectiveness of each instance of the training application. For example, the evaluation application may allow employers to analyze the differences between the application instances and/or determine possible causes for underperformance or low participation in a particular instance. In turn, the employer can then address these issues, such as by ensuring that each instance of the application has the correct balance of different types of users.

According to certain embodiments, the evaluation application may incorporate various data and statistics in addition to the user tracking data associated with the training application. In certain of these embodiments, employers may be able to import outside data and statistics (e.g., real-world sales or performance data). This external data can be compared with all or part of the data stored by the training application. As a result, employers can combine and correlate various sets of data and mine the data to find patterns and trends that indicate improvement and/or a lack of improvement by employees. For example, the real-world performance data can be used to assist in identifying employees that need additional training or skills that should be emphasized, and/or to further analyze the effectiveness of various activities provided through the training application. In addition, employers can view, from a data perspective, what separates their star employees from the crowd and, in turn, adjust the metrics and criteria used in the evaluation application to identify such employees. For example, based on the external data, employers may determine that most effective managers at the company correspond to the users that have the highest level of collaboration and assistance to other users through the training platform.

As shown by the foregoing, the features and functionality associated with the evaluation application provide employers and organizations with a powerful tool for evaluating and tracking their employees and other individuals. Importantly, the evaluation application enables companies to continually improve the effectiveness of and encourage participation in the training platform through a circular process in which the training platform can be updated in response to the analysis obtained via the evaluation application. In turn, this leads to faster and more effective improvements in the company's workforce through the training platform.

### Exemplary Training and Evaluation Application

The following provides certain examples of portions of a training and evaluation application and/or environment that may be accessed by and displayed to users of the training and evaluation platform, such as the training and evaluation platform illustrated and described in connection with FIGS. 1-3, in accordance with certain embodiments. In certain of these embodiments, such as where the training and evaluation platform is provided in the form of a web application, the web application may be accessed through a website via Internet-enabled devices associated with the users (e.g., smartphones, tablets, laptops, desktops, etc.).

For example, the website may present users with a series of web pages that allow the users to navigate through the web application and view and interact with various content, features and functionalities associated with the application in order to participate in and perform evaluation, training, collaborative and other related activities, tasks and actions. In certain of these embodiments, some or all of the content, features and functionalities associated with the web application may be presented in the form of one or more tabs within a single web page, or any other format or layout suitable for use within a web based application or environment. In certain embodiments, the web page or pages associated with the training and evaluation application and/or environment may be in a format and/or may include content, features and or functionalities suitable for access by and presentation on mobile devices, such as smartphones and tablets.

FIGS. 5-16 and the corresponding descriptions below illustrate and describe certain exemplary web pages (or portions thereof) that are associated with a training and evaluation web application and/or environment that may be accessed by users in connection with accessing the training and evaluation platform and participating in or performing various activities, tasks and actions. It should be understood that the particular format, content, features, and functionality of the training and evaluation application and/or environment described below and/or illustrated in FIGS. 5-16 are intended to be exemplary in nature, not exhaustive, and various other formats, content, features and/or functionalities may be used in connection with the training and evaluation platform, corresponding arrangements and systems and methods described herein. For example, in certain other embodiments, the training and evaluation platform (or a portion thereof) could be provided in the form of a mobile application for one or more types of mobile devices (e.g., smartphones, tablets, etc), in which case, the pages illustrated in FIGS. 5-16 and described below, may be included within and/or displayed via the mobile application.

FIG. 5 is a pictorial diagram illustrating a portion of the display of a training application having a user login page that may be presented to users of the training and evaluation platform, according to certain embodiments. As shown in FIG. 5, in certain embodiments, the training and evaluation application may include user login page 100, which may be displayed to users in response to the user requesting access to the training and evaluation platform. In certain of these embodiments, user login page 100 may include one or more form fields, such as username field 102 and password field 104, which allow the user to enter various authentication and/or identification information. User login page 100 may also include one or more buttons, such as login button 106, which allow users to access the platform and/or certain portions thereof. In certain of these embodiments, after a user has provided certain required information and logged into the platform through a particular device associated with the user, the training and evaluation platform may enable users to auto-login to the platform via the device, such as by storing a cookie on the device having the user's login information.

In certain other embodiments (not illustrated in FIG. 5), user login page 100 may include a number of buttons or options that allow users to access different portions of the training and evaluation platform. For example, user login page 100 may allow users to select an option to access a training portion or evaluation portion of the application. Similarly, in certain embodiments, such as where the platform is implemented as a number of separate instances, user login page 100 may allow users to select an option to access a particular instance of the platform, such as by choosing an instance from a drop-down list of the available instances of the platform. In certain of these embodiments, the training and evaluation application may require the users to re-login in order to access other portions or instances of the platform, such as by providing separate login credentials.

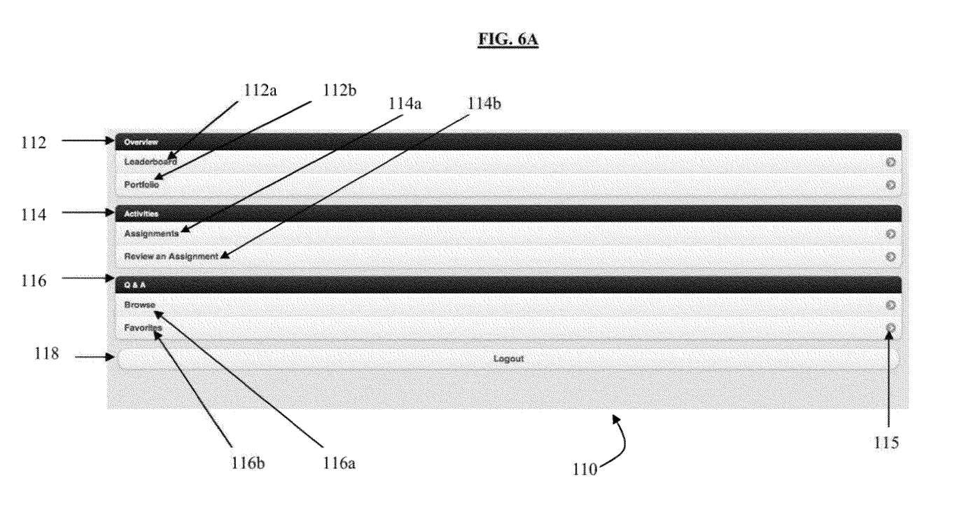

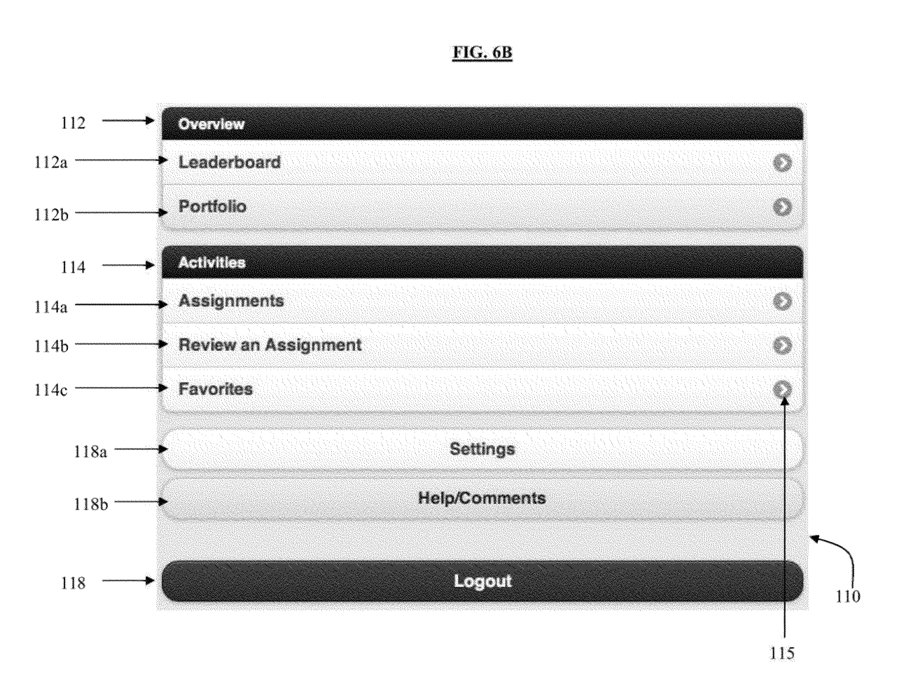

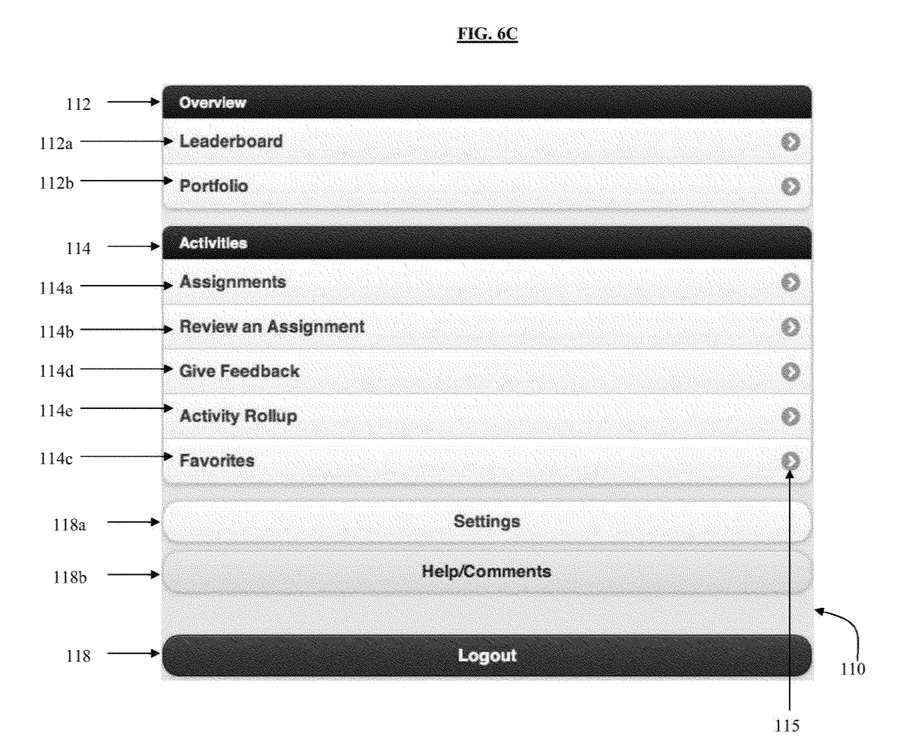

FIGS. 6A-6C are exemplary illustrations of a main navigation interface that may be included in a web application through which users may access, select, and navigate to various portions and features of the training and evaluation platform. FIG. 6A is a pictorial diagram illustrating a portion of the display of a training application having a home navigation page that may be presented to users of the training and evaluation platform, according to certain embodiments. As shown in FIG. 6A, in certain embodiments, the training and evaluation application may include home navigation page 110, which may be displayed to users to allow the users to navigate to and/or access various portions of the application, such as training and collaborative activities, leaderboards, Question & Answer boards, etc. In certain embodiments, home navigation page 110 may include one or more navigation categories such as overview navigation category 112, activities navigation category 114, and Q&A navigation category 116, as illustrated in FIG. 6A.

In certain of these embodiments, some or all of the navigation categories may include various navigation links associated with one or more portions of the application that a user may view and/or access by selecting the navigation link. For example, as shown in FIG. 5A, overview navigation category 112 includes leaderboard navigation link 112a which may be associated with one or more leaderboards accessible to the user and portfolio navigation link 112b which may be associated with various information for the user, such as background or profile information, historical activity data, reviews and/or feedback, etc. Similarly, activities navigation category 114 includes assignments navigation link 114a which may be associated with one or more training activities assigned or recommended to the user and review navigation link 114b which may be associated with one or more collaborative activities that are available to the user. As another example, Q&A navigation category 116 includes browse navigation link 116a which may be associated with displaying all of the questions and responses submitted by users to a Question & Answer board and favorites navigation link which may be associated with displaying a subset of the questions and responses, such as those that the user has previously bookmarked or flagged as important or useful. According to certain of these embodiments, some or all of the navigation links may include one or more icons, such as selection icons 115 shown in FIG. 6A, to indicate that the user may navigate to the specified area or content by selecting (e.g., clicking or touching) the navigation link. In addition, as shown in FIG. 6A, home navigation page 110 may include various buttons, such as logout button 118, which allows users to exit the training and evaluation platform.

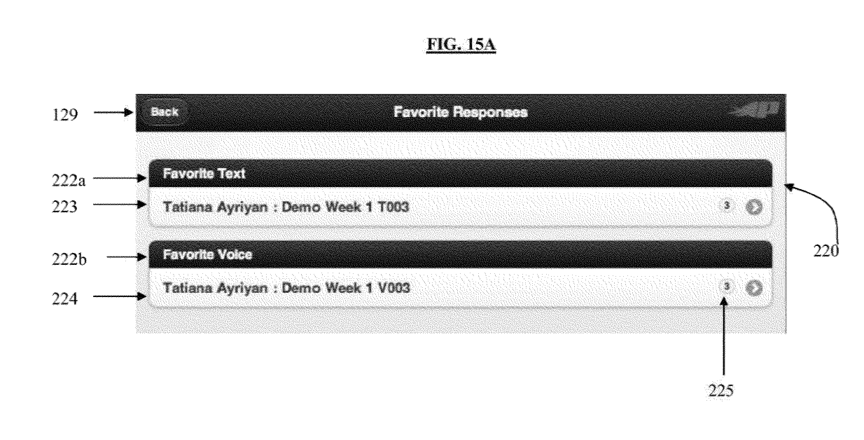

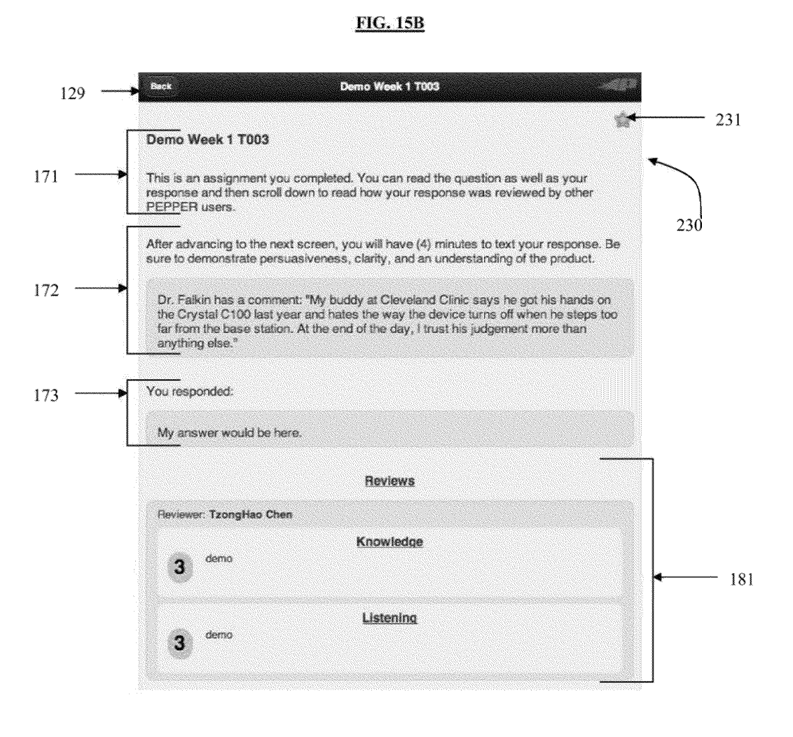

FIG. 6B is a pictorial diagram illustrating a portion of the display of a training application having a home navigation page that may be presented to users of the training and evaluation platform, according to certain other embodiments. As shown in FIG. 6B, home navigation page 110 (like home navigation page 110 shown in FIG. 6A) includes one or more navigation categories and/or navigation links, such as overview navigation category 112, having leaderboard navigation link 112a and portfolio navigation link 112b, as well as activities navigation category 114, having assignments navigation link 114a and review navigation link 114b, which may be displayed to users to allow the users to navigate to and/or access various portions of the application. In certain embodiments, activities navigation category 114 may also include favorite reviews navigation link 114c, which may be associated with one or more reviews, ratings, and/or feedback provided by other users, such as those that the user has previously bookmarked or flagged as important or useful (as illustrated and discussed further in connection with FIGS. 15A and 15B below). Also, as shown in FIG. 6B, in addition to logout button 118, home navigation page 110 may include other buttons, links, or the like, such as settings button 118a, which may allow the user to select and/or modify various settings and preferences associated with the application and support button 118b, which may allow the user to obtain support for the application, such as by contacting a help-desk via the user's phone.

In certain embodiments, the training application may include a number of different home navigation pages, each having a particular set of navigation categories, navigation links, buttons, layouts, etc. In certain of these embodiments, the layout of the home navigation page and the categories, links, buttons and content displayed therein (or a portion thereof) may be customizable by the users, such as by allowing users to select display preferences or customize the page layout. In certain other embodiments, the layout, format and content of the home navigation page may be based on the type of user, such as by associating a particular predefined home navigation page with each user role. According to certain of these embodiments, the navigation categories and/or navigation links that are included in each predefined home navigation page may be based on the types of activities, features and portions of the application that are accessible to users associated with each user role.

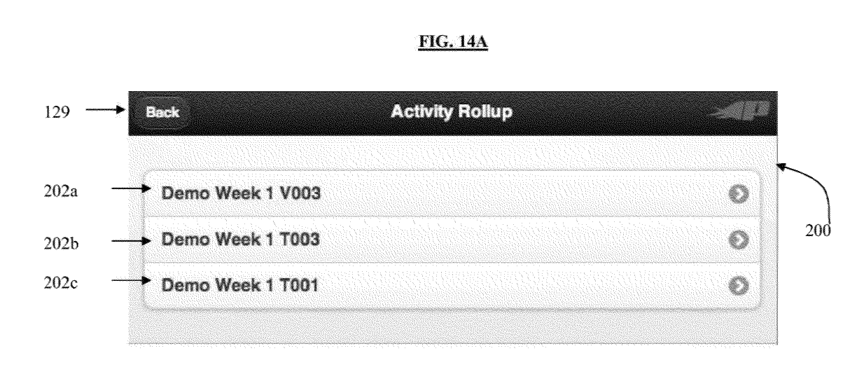

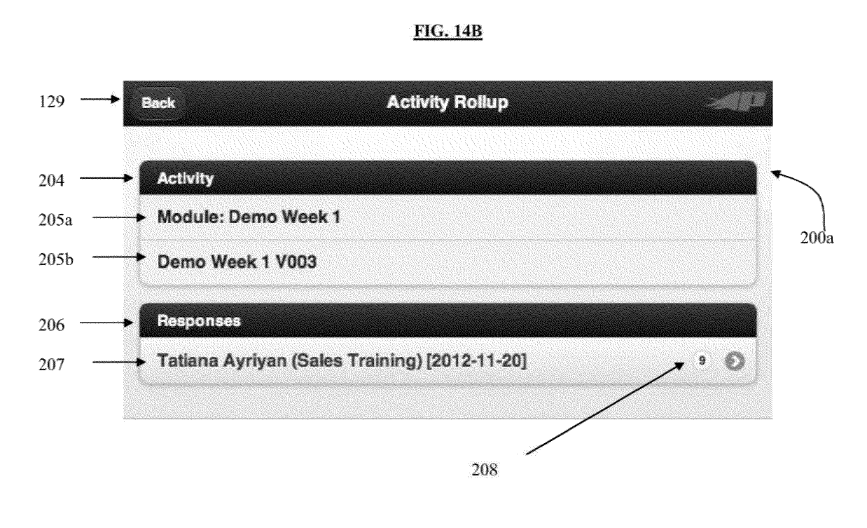

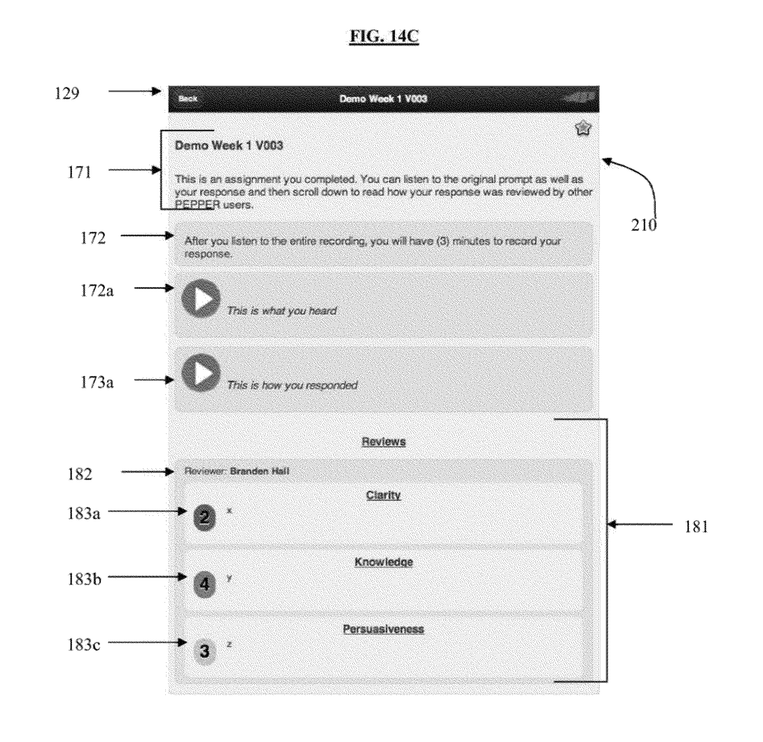

For example, in certain embodiments home navigation page 110, as shown in FIG. 6B, may be displayed to general users of the training application, such as users associated with a “Player” user role. As another example, in certain embodiments home navigation page 110, as shown in FIG. 6C (described below), may be displayed to users associated with a higher role, such as users associated with a “Captain” and/or “Coach” user role. FIG. 6C is a pictorial diagram illustrating a portion of the display of a training application having a home navigation page that may be presented to users of the training and evaluation platform, according to yet other embodiments. As shown in FIG. 6C, home navigation page 110 may include all of the navigation categories, navigation links and buttons included in home navigation page 110 of FIG. 6B. In certain embodiments, home navigation page 110 may also include other navigation categories, navigation links, and/or buttons in addition to, or instead of those shown in FIG. 6B. For example, as shown in FIG. 6C, activities navigation category 114 may also include feedback navigation link 114d, which may be associated with collaborative activities that allow the user to provide feedback on other users' reviews, and activity rollup navigation link 14e, which may be associated with an activity rollup feature (as illustrated and described further in connection with FIGS. 14A-14C below).

While the exemplary home navigation pages illustrated in FIGS. 6A-6C are shown as having the particular navigation categories and links with certain names, as described above, it should be understood that any number and type of such navigation categories and links having any name or other designation may be used to allow users to navigate to and access various pages, features and functionalities associated with the training and evaluation application. In certain embodiments, home navigation page 110 may also include one or more additional navigation buttons, links, options, or the like. For example, in certain embodiments, the home navigation page may include one or more buttons that allow users to access an evaluation portion of the training and evaluation platform, and/or other instances of the platform.

In certain embodiments, the training and evaluation platform may allow users to modify and customize the format or layout of the home navigation page and/or the particular navigation categories and links displayed thereon. For example, users may be able to add, remove, move, and/or rename navigation categories and links or create new navigation links to access certain portions of the platform. In certain other embodiments, the format and layout of the home navigation page and the navigation categories and links may be customized by the organization and/or dictated by the type of user (e.g., based on the user's role).

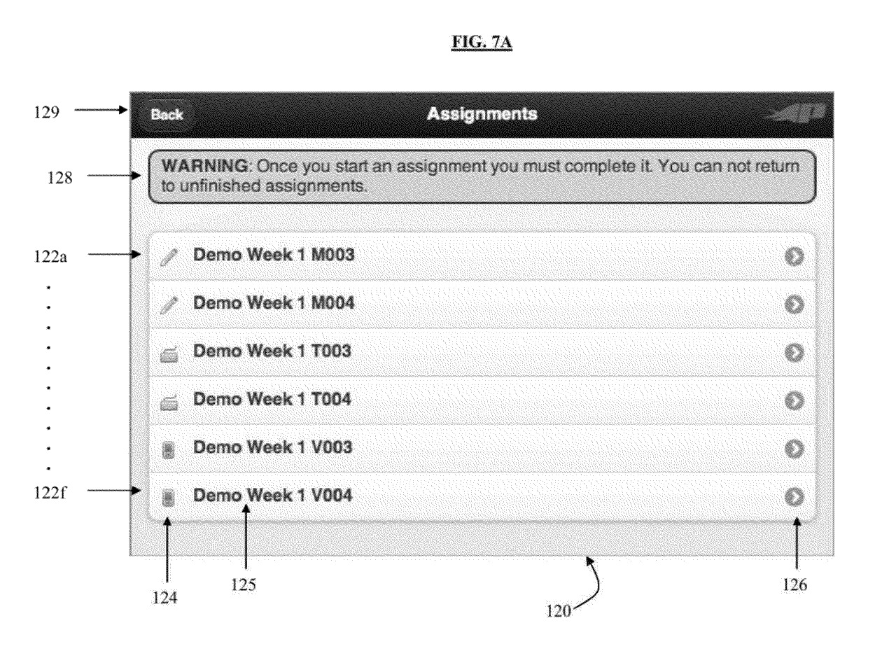

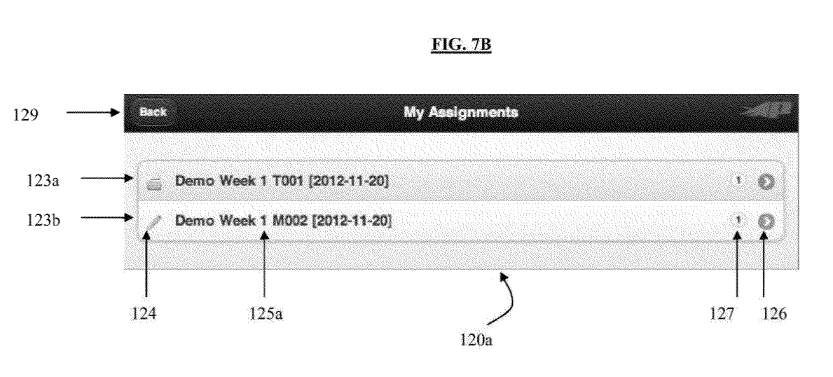

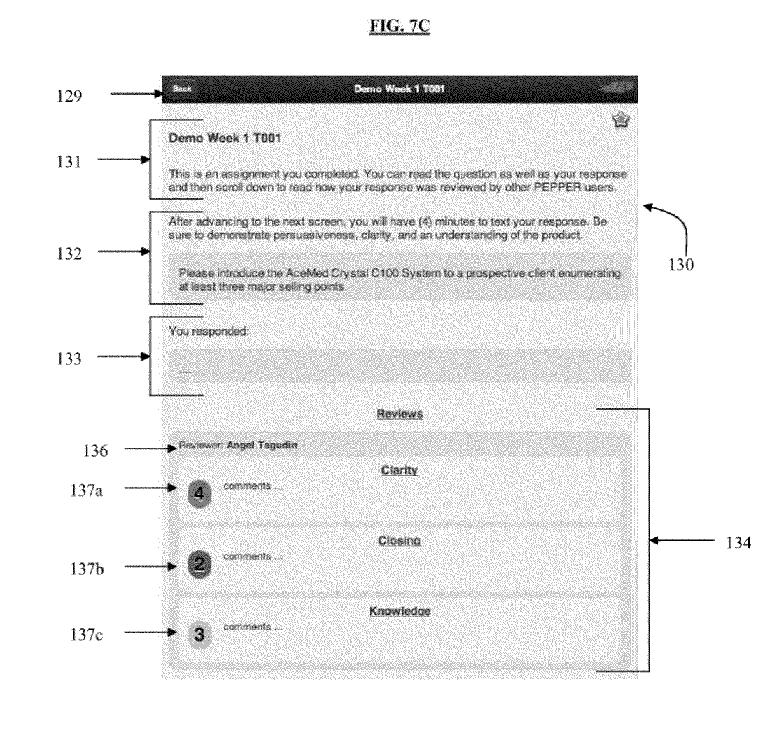

FIGS. 7A-7C show exemplary web pages that may be included in a web application through which users may access, view, select, and navigate to one or more training assignments, such as training activities assigned to the user and/or training activities that have previously been completed by the user. FIG. 7A is a pictorial diagram illustrating a portion of the display of a training application having an assignments page that may be presented to users of the training and evaluation platform, according to certain embodiments. As shown in FIG. 7A, in certain embodiments, the training and evaluation application may include assignments page 120, which allows a user to view and/or select various training activities, such as training activities that have been assigned or recommended to the user or all of the training activities that are accessible to the user through the platform. In certain embodiments, assignments page 120 may display a list of training activity links, such as training activity links 122a-122f illustrated in FIG. 7A, that allow the user to select the specified training activity. In certain embodiments, assignments page 120 may include other information or content, such as assignments message 128, which may display instructions, hints, help text, warning messages, or the like to users. Assignments page 120 may also include one or more buttons or links, such as back button 129, which allow users to navigate to other portions of the application, such as back to the home navigation page.

According to certain embodiments, some or all of the training activity links displayed on assignments page 120 may include various icons, images, text, or the like that indicate certain information associated with the corresponding training activities. For example, as shown in FIG. 7A, each training activity link may include an icon, such as training format icons 124, that may be associated with the format of the training activity (e.g., multiple choice, short answer, voice response). Each training activity link may also include a title associated with the training activity, such as training activity names 125, which may include the name of the training activity and/or a training module associated with the training activity, activity selection icons 126, which may allow the user to select and perform the desired training activity, and/or activity point values (not shown), which may indicate the point value or maximum point value associated with completing the training activity.

In certain embodiments, assignments page 120 may display all of the training activities that are accessible to the user, including training activities that have not been started, training activities that are in-progress and/or training activities that have been completed by a user. As a result, the user may select a training activity link for a training activity that the user has not yet started or that is in-progress in order to begin or continue the training activity. In certain other embodiments, assignments page 120 may display a subset of the training activities that are accessible to the user, such as limiting the displayed training activities to those that have yet to be started or are incomplete, have been assigned to the user, and/or are associated with one or more formats or categories of training. Alternatively, or in addition, the platform may allow the user to sort or filter the training activities displayed through assignments page 120. For example, the user may be able to sort or filter the displayed training activities based on the format or category of training, the expiration date of the activities, the status of the activities, and/or the point values associated with the activities. In certain embodiments, assignments page 120 may allow users to search through some or all of the training activities accessible to the user based on various search parameters.

FIG. 7B is a pictorial diagram illustrating a portion of the display of a training application having a my assignments page including one or more previously completed training activities that may be presented to users of the training and evaluation platform, according to certain embodiments. As shown in FIG. 7B, in certain embodiments, the training and evaluation application may include my assignments page 120a, which allows a user to view and/or select various training activities, such as some or all of the training activities that have already been completed the user through the platform. In certain of these embodiments, my assignments page 120a may display a list of completed training activity links, such as completed training activity links 123a and 123b illustrated in FIG. 7B, that allow the user to select the specified completed training activity. In certain embodiments, each completed training activity link may include one or more icons or other information in a similar manner to the training activity links described in connection with FIG. 7A. The completed training activity links may also include other icons or information, such as training activity names 125a, which may include the date and/or time that the user completed the activity, as well as the name of the training activity and/or a training module associated with the training activity, and activity point awards 127, which may indicate the point value awarded to the user for completing each training activity. In certain of these embodiments, activity point awards 127 may be modified or updated periodically, such as in response to another user reviewing the user's performance of the training activities.

In certain embodiments, the user may be allowed to select a completed training activity link in order to view various information associated with the user's performance, such as response, results, points or scores, and/or other user's reviews or comments. In certain of these embodiments, the completed training activity links associated with each training activity may include an indication of the status of each activity (i.e., new, in-progress, completed, updated, reviewed, etc.), such as to emphasize activities that are about to expire or activities that are required or have a high priority and/or to indicate new reviews or comments for training activities previously completed by the user.

FIG. 7C is a pictorial diagram illustrating a portion of the display of a training application having a completed training activity page that may be presented to users of the training and evaluation platform, according to certain embodiments. As shown in FIG. 7C, in certain embodiments, such as where a user selects a completed training activity link included in a my assignments page, the training and evaluation application may display completed training activity page 130, which includes certain information associated with a training activity previously completed by the user. For example, as illustrated in FIG. 7C, completed training activity page 130 includes activity information 131, which may display the name of the activity and/or other general information, activity instructions 132, which may display the question and/or scenario associated with the activity, and/or activity response 133, which may display the user's responses to the activity (or a portion thereof).

In certain embodiments, completed training activity page 130 may also include reviews summary portion 134, which displays information associated with one or more other users who have reviewed the user's performance of the training activity. According to certain of these embodiments, reviews summary portion 134 may include various information associated with each review, such as reviewer name 136 and review category ratings 137a-137c, which may indicate the scores, comments and/or other information provided by the reviewer for one or more review categories associated with the training activity, such as skills or domains (e.g., clarity, closing, knowledge) that are intended to be evaluated and/or improved through performance of the activity. Although only one review is shown in FIG. 7C for simplicity, it should be understood that in certain embodiments reviews summary portion 134 may include any number of reviews associated with any number of other users who have reviewed the user's performance of the training activity.

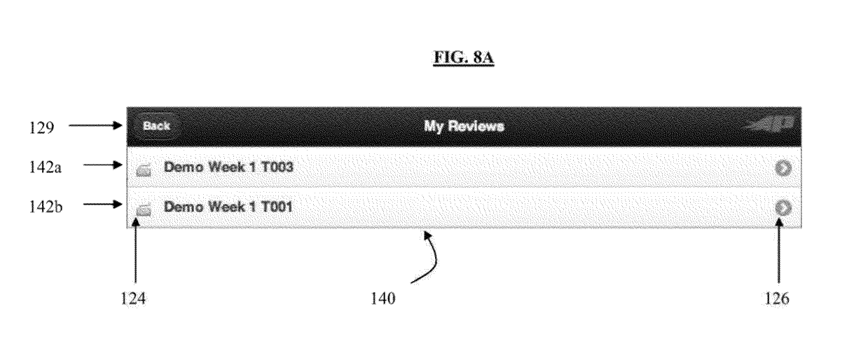

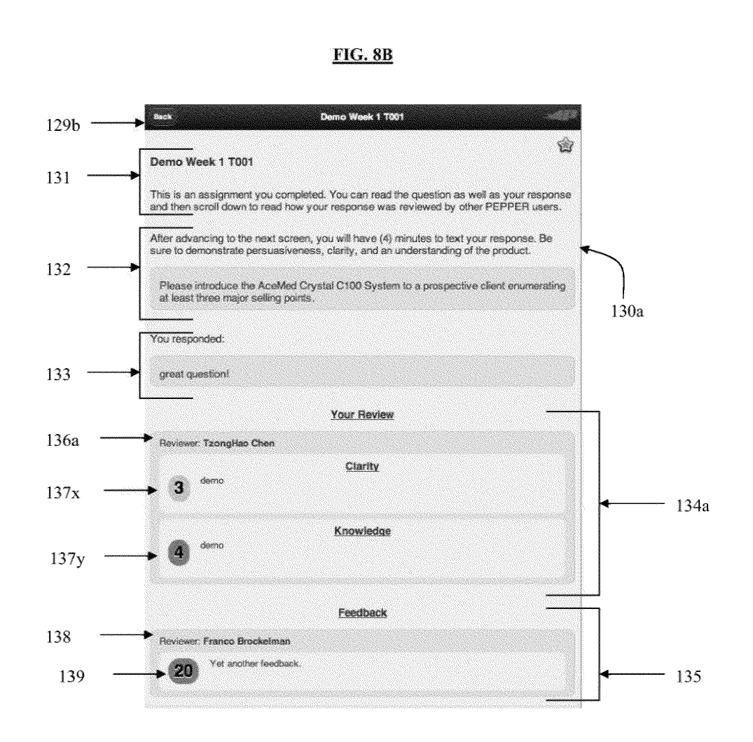

FIGS. 8A and 8B show exemplary web pages that may be included in a web application through which users may access, view, select, and navigate to one or more collaborative review assignments, such as collaborative review activities assigned to the user and/or collaborative review activities that have previously been completed by the user. In certain embodiments, the training and evaluation application may include a reviews page that displays all of the collaborative review activities that are accessible to the user, including training activities that have not been started, training activities that are in-progress and/or training activities that have been completed by a user. As a result, the user may select a collaborative review activity link for a training activity that the user has not yet started or that is in-progress in order to begin or continue the collaborative review activity. In certain other embodiments, the reviews page may display a subset of the collaborative review activities that are accessible to the and/or may allow the user to sort, filter and/or search through the collaborative review activities displayed through the reviews page, such as in a similar manner to the training activities discussed above in connection with FIGS. 7A-7C

FIG. 8A is a pictorial diagram illustrating a portion of the display of a training application having a my reviews page including one or more completed collaborative review activities that may be presented to users of the training and evaluation platform, according to certain embodiments. As shown in FIG. 8A, in certain embodiments, the training and evaluation application may include my reviews page 140, which allows a user to view and/or select various collaborative review activities, such as collaborative review activities that have been previously completed by the user through the platform. In certain embodiments, my reviews page 140 may display a list of completed collaborative review activity links, such as completed collaborative review activity links 142a and 142b illustrated in FIG. 8A, that allow the user to select the specified completed activity. In certain embodiments, some or all of the completed collaborative review activity links displayed on my reviews page 120 may include various icons, images, text, or the like that indicate certain information associated with the corresponding collaborative review activities. For example, as shown in FIG. 8A, each completed collaborative review activity links may include an icon, such as training format icons 124, that may be associated with the format of the training activity (e.g., multiple choice, short answer, voice response) that was reviewed by the user, as well as a title associated with the training activity and/or activity selection icons 126.

FIG. 8B is a pictorial diagram illustrating a portion of the display of a training application having a completed review activity page that may be presented to users of the training and evaluation platform, according to certain embodiments. As shown in FIG. 8B, in certain embodiments, such as where a user selects a completed collaborative review activity link included in a my reviews page, the training and evaluation application may display completed review activity page 130a, which includes certain information associated with a collaborative review activity previously completed by the user. For example, as illustrated in FIG. 8B, completed review activity page 130a includes activity information 131, activity instructions 132, and/or activity response 133, which may display information associated with the training activity and training activity response that was reviewed by the user. In certain embodiments, completed review activity page 130a may also include my review portion 134a, which displays information associated with the user's review of the training activity performance. According to certain of these embodiments, my review portion 134a may include various information associated with the user's review, such as reviewer name 136a (i.e., the user's name) and review category ratings 137x and 137 y, which may indicate the scores, comments and/or other information provided by the user for one or more review categories associated with the training activity.

According to certain embodiments, completed review activity page 130a may include feedback summary portion 135, which displays certain information associated with one or more other users' ratings of the user's review. For example, as shown in FIG. 8B, feedback summary portion 135 may include feedback reviewer name 138, and feedback rating information 139, which may include one or more scores, comments and/or other feedback provided by the other user. Although only one rating is shown in FIG. 8B for simplicity, it should be understood that in certain embodiments feedback summary portion 135 may include any number of ratings and/or feedback associated with any number of other users who have rated the user's review.

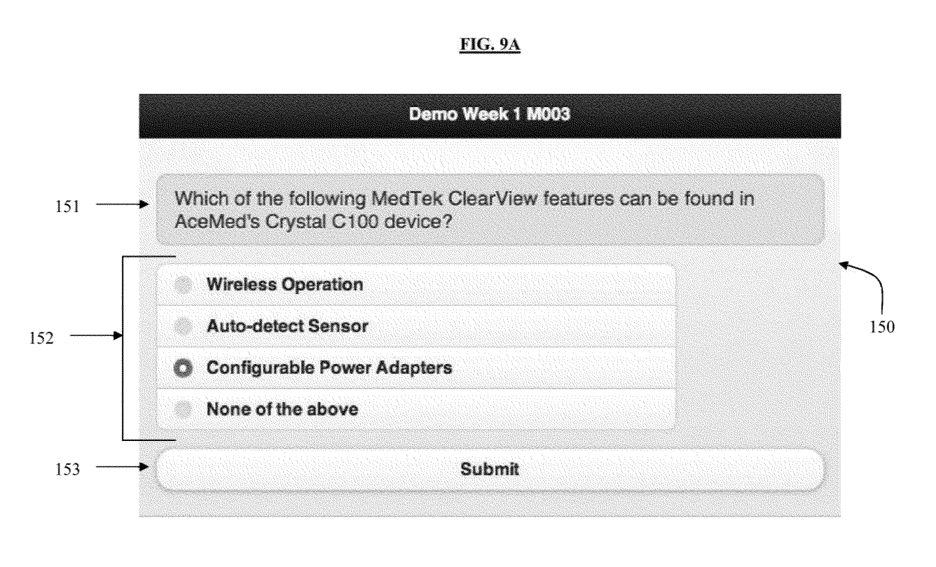

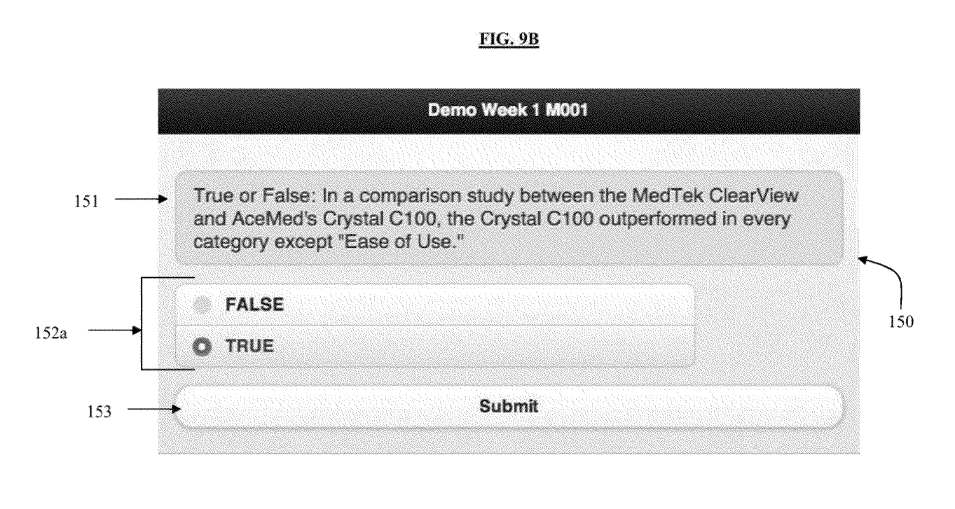

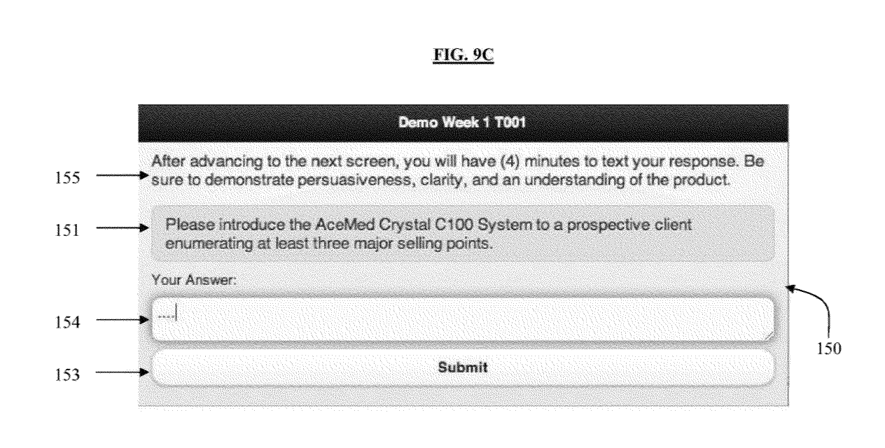

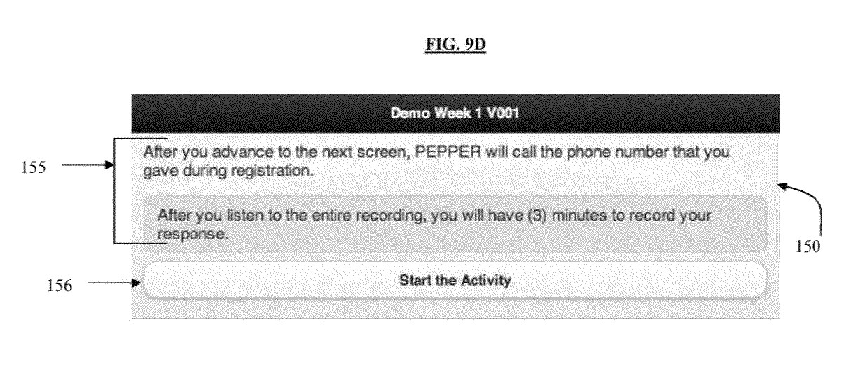

FIGS. 9A-9D illustrate exemplary portions of the types of activities (e.g., questions, scenarios, simulations, etc.) that may be included in training activities made accessible to users through the training and evaluation platform. The particular activities illustrated in FIGS. 9A-9D and described below are exemplary in nature, not exhaustive, and are intended to show how training activities may be implemented in the training and evaluation platform according to certain embodiments. It should be understood, however, that the platform may include any number, type, and/or format of training activities, presented using any suitable display format and layout.

FIG. 9A is a pictorial diagram illustrating a portion of the display of a training application having a training activity page including a multiple-choice activity that may be presented to users of the training and evaluation platform, according to certain embodiments. As shown in FIG. 9A, the training and evaluation platform may display a training activity (or portion thereof) to users in training activity page 150. In certain embodiments, training activity page 150 may be a separate page. In certain other embodiments, training activity page 130 may be displayed as a sub-page within another page, or may be displayed as a pop-up window.

In certain embodiments, such as where the training activity is a multiple-choice activity, one or more questions may be displayed to users in training activity page 150. For example, as illustrated in FIG. 9A, training activity page 150 includes question 151, and answer selections 152, which in this case include three possible answers to question 151. In certain embodiments, answer selections 152 may be presented using form fields, such as radio buttons, which allow the user to select an answer (e.g., by clicking or touching the desired answer). In certain other embodiments, answer selections 152 may be displayed using any suitable format that allows the user to choose and/or input an answer. As shown in FIG. 9A, training activity page 130 may also include submit button 153, which allows the user to submit his or her answer to question 151. In certain other embodiments, the user's answer may be automatically submitted, such as when the user selects one of answer selections 152.

FIG. 9B is a pictorial diagram illustrating a portion of the display of a training application having a training activity page including a true-false activity that may be presented to users of the training and evaluation platform, according to certain embodiments. As illustrated in FIG. 9B, in certain embodiments, such as where the training activity is a true-false activity, training activity page 150 includes question 151, and answer selections 152a, which in this case include two possible selections (i.e., true or false) to question 151.

FIG. 9C is a pictorial diagram illustrating a portion of the display of a training application having a training activity page including a short-answer activity that may be presented to users of the training and evaluation platform, according to certain embodiments. As shown in FIG. 9C, in certain embodiments, such as where the training activity is a short answer activity, training activity page 150 includes question 151 and answer input section 154, which may be in the form of a text input box or any other suitable input mechanism, that allows the user to input a text-based response to question 151. In certain embodiments, training activity page 150 may include various instructions, hints, etc. associated with the activity, such as activity instructions 155, as shown in FIG. 9C. In certain of these embodiments, for example, the user may be given a limited period of time in which to respond to question 151.

FIG. 9D is a pictorial diagram illustrating a portion of the display of a training application having a training activity page including a voice simulation activity that may be presented to users of the training and evaluation platform, according to certain embodiments. As shown in FIG. 9C, in certain embodiments, such as where the training activity is voice simulation activity, training activity page 150 includes activity instructions 155 and start activity button 156, which allows the user to begin the voice simulation exercise. For example, in certain of these embodiments, when the user selects start activity button 156, the user may then receive a simulated phone call on the user's smartphone or other mobile device.

In certain embodiments, such as where the training activity is a multiple choice, true-false, or short answer training activity that includes one or more questions, the questions may be displayed one at a time in the training activity page. For example, when the user chooses an answer and selects the submit button, the next question may be displayed in the training activity page. In certain of these embodiments, the new question may be predefined, or may be generated based on the user's responses to one or more previous questions in the activity. In certain embodiments, the training activity page may determine and display the result or score of the user's response to the question, such as after the user selects the submit button. In certain other embodiments, the user may be allowed to navigate back and forth through the list of questions and/or modify a previously selected answer, in which case, the result may be determined and displayed after the user has answered all of the questions and/or indicated that he or she has finished the activity. According to certain embodiments, such as where the training activity is a voice or other type of simulation, short answer or essay, the training and evaluation platform may skip the step of determining a result or score and simply record and/or store the user's responses to the activity. In turn, this allows the training and evaluation platform to generate one or more collaborative activities based on the user's responses to the training activity, such as in a similar manner to that described above.

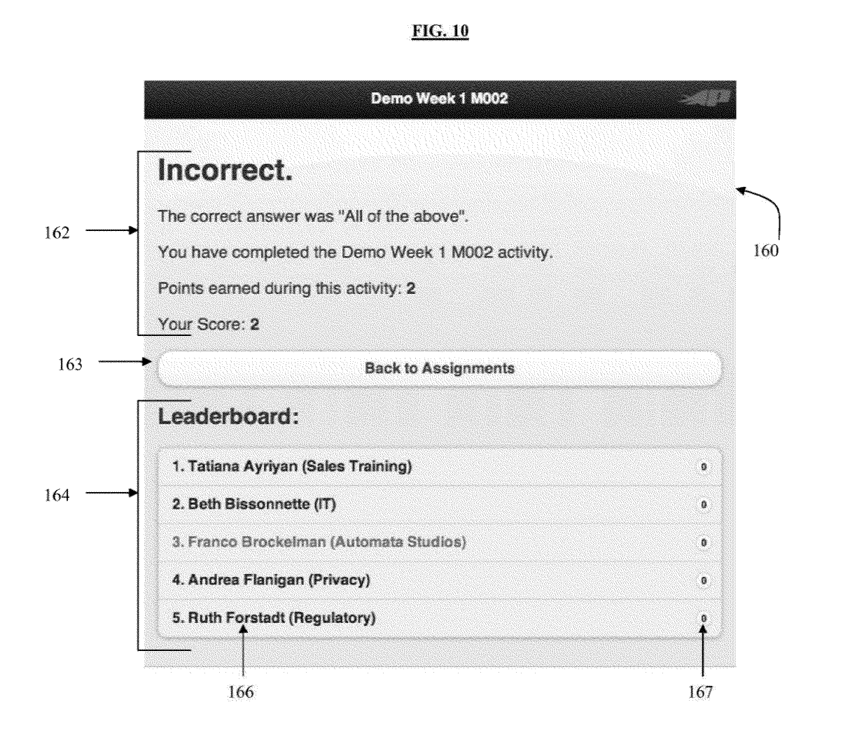

FIG. 10 is a pictorial diagram illustrating a portion of the display of a training application having a training activity results page that may be presented to users of the training and evaluation platform, according to certain embodiments. In certain embodiments, such as after a user has completed a training activity, the training and evaluation platform may determine a score or result based on the user's responses or selections and display the score in a training activity results page. For example, as shown in FIG. 10, training activity results page 160 includes results text 162, which may include various information associated with the user's performance, such as the number of questions answered correctly, a detailed breakdown of the result for each question and/or an overall score and/or sub-scores (e.g., broken down by category or section, etc.). Training activity results page 160 may also include one or more buttons, such as back button 163, which may allow the user to return to an assignments or my assignments page.

In certain embodiments, such as where the training and evaluation platform uses gamified and/or group training concepts, results text 162 may display a score and/or the points earned by the user for completing the training activity. In certain of these embodiments, training activity results page 160 may also include leaderboard 164, which displays one or more users of the platform in an ordered list. As shown in FIG. 10, leaderboard 164 may include various information associated with each user displayed in the list, such as user title 166, which may include each user's name and their position or user role, and user scores 167. In certain of these embodiments, the leaderboard may display the users in an order according to user scores 167, which may be an overall score associated with each user based on all or a subset of the points awarded to the user through the platform. Alternatively, or in addition, user scores 167 may be based only on each user's score on the particular training activity that was just completed by the user, thereby allowing the user to see his or her relative performance for the activity.

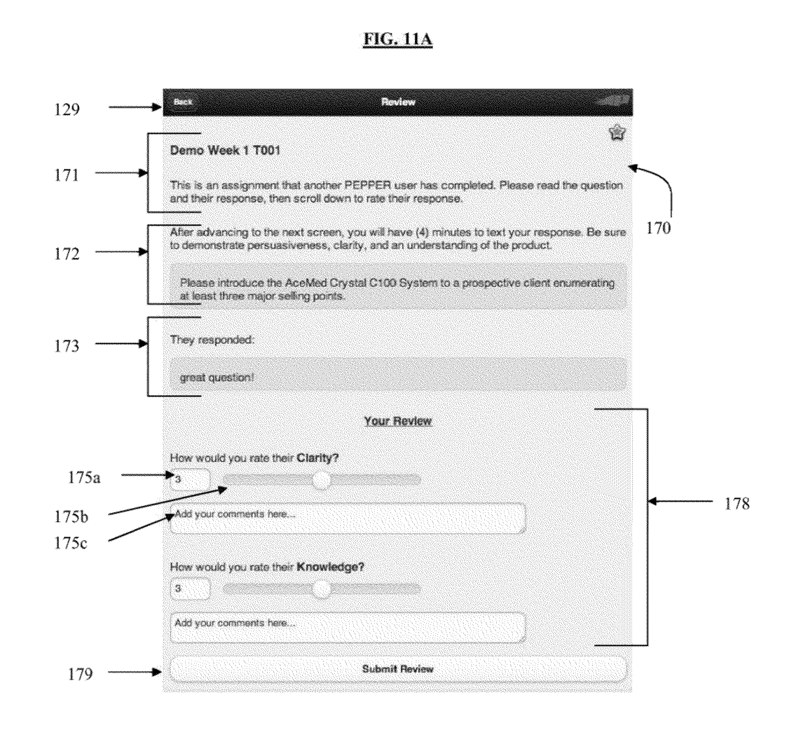

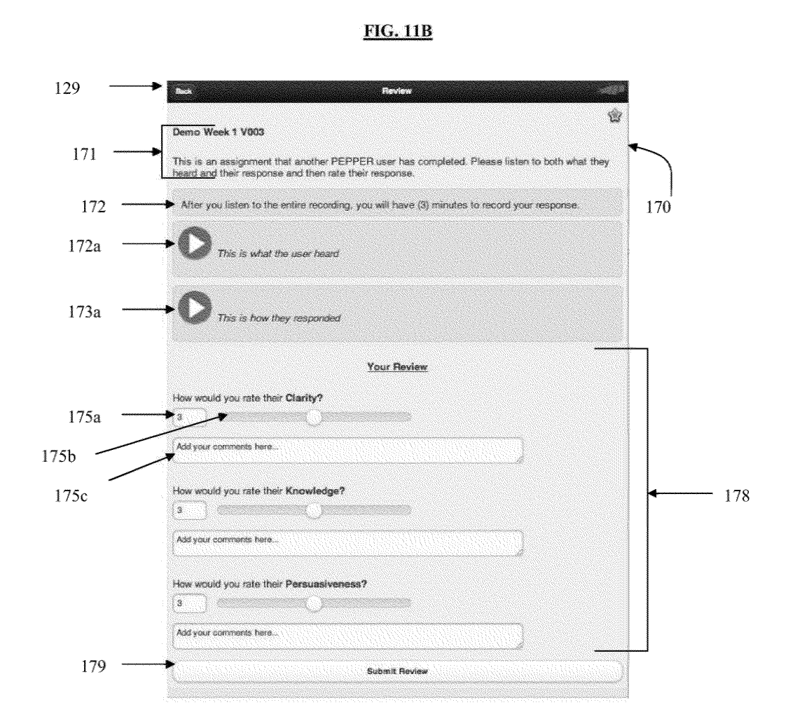

In certain embodiments, such as where various collaborative activities are generated and/or made available through the training and evaluation platform, certain users may be given the option to participate in one or more of the collaborative review activities. FIGS. 11A and 11B illustrate exemplary collaborative review activity pages that may be included in the training application to allow users to perform collaborative activities associated with reviewing another user's performance of a training activity.

FIG. 11A is a pictorial diagram illustrating a portion of the display of a training application having a collaborative review activity page associated with reviewing another user's performance of a training activity that may be presented to users of the training and evaluation platform, according to certain embodiments. As shown in FIG. 11A, a collaborative activity associated with reviewing another user's performance in a training activity is displayed in review activity page 170. Review activity page 170 may include various information that allows the reviewing user to view the training activity (e.g., the questions, instructions, etc.) and view and/or listen to the other user's responses during the training activity, such as training activity summary 171, training activity problem 172 and training activity response 173. In certain embodiments, training activity summary 171 provides a short description of the training activity performed by the other user, such as a short-answer question. Training activity problem 172 and training activity response 173 provide the reviewing user with access to the particular questions and/or instructions presented to the other user and the other user's responses, respectively.

In certain embodiments, review activity page 170 may include review input section 178 that allows the reviewing user to select and/or input various information associated with rating and/or reviewing the other user's performance of the training activity. For example, as shown in FIG. 11A, review input section 178 may include rating input field 175a and/or rating slider 175b, which allow the reviewing user to provide a numerical rating for the other user's performance, as well as comments input field 175c, which allows the reviewing user to input textual comments and feedback. In certain of these embodiments, such as shown in FIG. 11A, review input section 178 may include multiple sub-sections that allow the reviewing user to rate and/or review different aspects of the other user's performance. For example, review input section 178 may include sub-sections based on the skills or domains (e.g., leadership, clarity, product knowledge, passion) associated with the training activity. As another example, the training activity may have a number of separate parts, in which case the review input section may include sub-sections corresponding to each part of the training activity. In certain embodiments, after inputting the ratings and/or reviews, the reviewing user may select submit review button 179 to complete and submit the collaborative activity.

FIG. 11B is a pictorial diagram illustrating a portion of the display of a training application having a collaborative activity page associated with reviewing another user's performance of a training activity that may be presented to users of the training and evaluation platform, according to certain embodiments. As shown in FIG. 11B, in certain embodiments, such as where the collaborative review activity is associated with reviewing another user's performance in a voice simulation training activity, review activity page 170 may include one or more buttons, links, or the like, which allow the reviewer to listen to the voice simulation and/or the other user's voice responses thereto. For example, as shown in FIG. 11B, review activity page 170 may include voice simulation button 172a that allows the reviewing user to listen to the voice simulation heard by the other user and voice response button 173a that allows the reviewing user to listen to the other user's voice responses. Although, for the sake of clarity, particular types of input and selection fields are shown in FIGS. 11A and 11B and described above, it should be understood that any suitable input mechanisms may be used to allow the reviewing user to provide input associated with a rating and/or review of the other user's performance of the training activity.

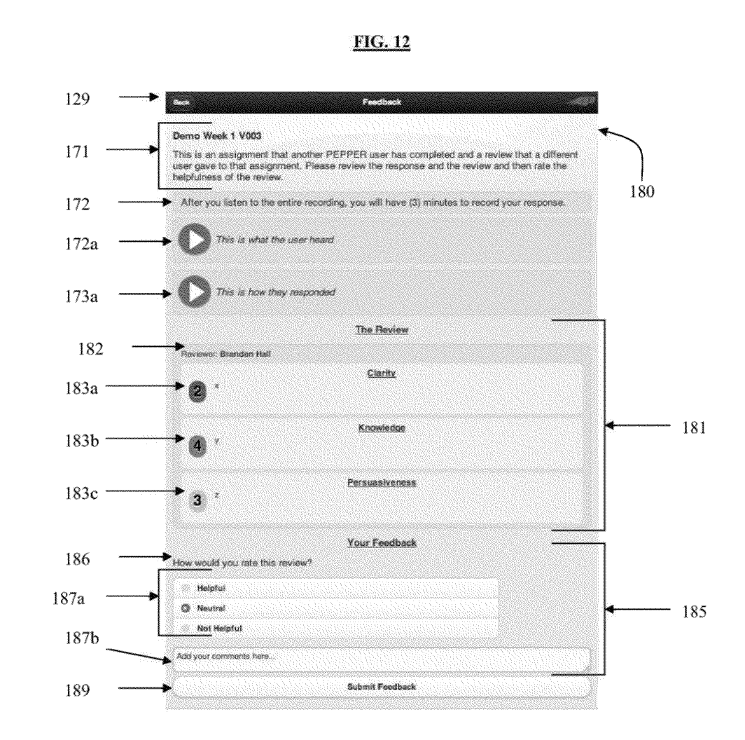

FIG. 12 is a pictorial diagram illustrating a portion of the display of a training application having a collaborative activity page associated with rating another user's review that may be presented to users of the training and evaluation platform, according to certain embodiments. In certain embodiments one or more users of the training and evaluation platform may be allowed to participate in “second-level” collaborative activities, in which the users rate and provide feedback based on other user's reviews of yet other user's performance of training activities. As shown in FIG. 12, these collaborative feedback activities may be displayed to users in feedback activity page 180. In certain of these embodiments, feedback activity page 180 may be displayed in a similar manner to, and/or include similar information as, review activity page 170 (as shown and described above in connection with FIGS. 11A and 11B). For example, feedback activity page 180 may include various information and links that allow the feedback user to view the training activity information and view and/or listen to the training user's participation in the training activity, such as training activity summary 171, training activity problem 172, voice simulation button 172a, and/or voice response button 173a. Feedback activity page 180 also includes a review summary section 181, which may display various information associated with the reviewing user, such as reviewer name 182, and/or the scores and reviews provided by the reviewing user. In certain of these embodiments, review summary section 181 may be broken down into multiple review categories, such as review categories 183a-183c, that correspond to the separate aspects (e.g., skills, domains, etc.) reviewed or rated by the reviewing user. According to certain embodiments (not shown), feedback activity page 180 may include a number of review summaries, each associated with a reviewing user who has provided a review of the training user's performance.

As illustrated in FIG. 12, feedback activity page 180 may include a feedback input section 185, which allows the feedback user to input and/or select information associated with rating and/or providing feedback to the reviewing user's review. In certain embodiments, feedback input section 185 may include various information and form fields in a similar manner as described above in connection with the review input section. For example, feedback input section 185 may include feedback question 186, feedback answer selections 187a (e.g., selectable radio buttons), and feedback comments input field 187b. In certain of these embodiments, the feedback user may be required to simply select a rating from a number of predefined choices (e.g., useful, neutral, not useful), as shown in FIG. 12. In certain other embodiments (not shown in FIG. 12), feedback input section 185 may also, or alternatively, include a score input field that allows the feedback user to provide a numerical score or rating for the review. In certain embodiments, after the feedback user has finished inputting and/or selecting the desired feedback, the user may submit the feedback by selecting a button or link, such as submit feedback button 189 shown in FIG. 12.

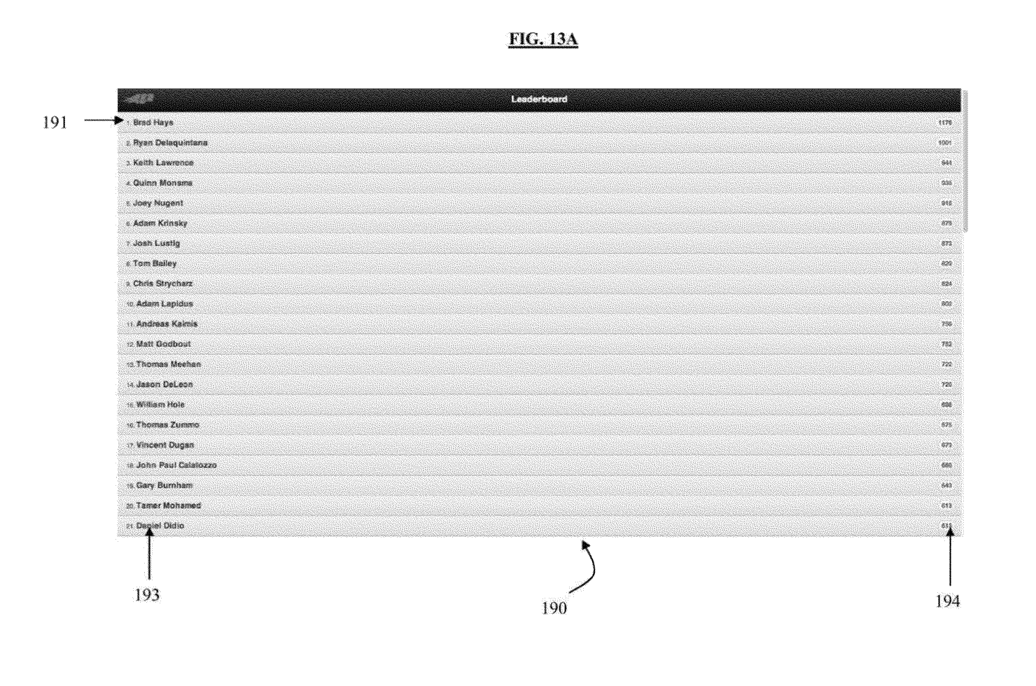

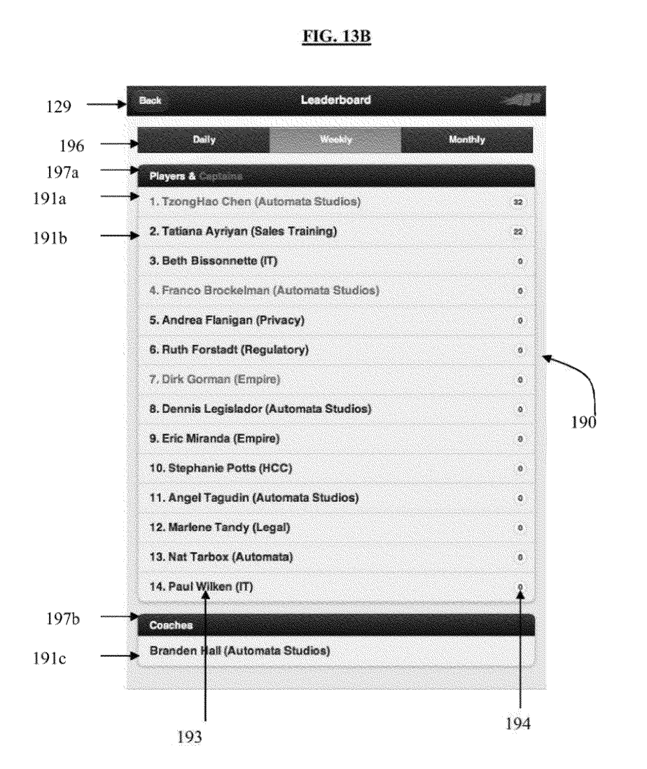

In certain embodiments, such as where the training and evaluation platform utilizes gamified and/or group training concepts, the training and evaluation platform may generate and make accessible one or more leaderboards to users of the platform, some of which may be limited to a subset of the users of the platform. For example, the training and evaluation platform may generate a leaderboard that is limited to users that are associated with one or more user roles. FIGS. 13A and 13B illustrate exemplary leaderboards that may be generated and displayed through the platform. It should be understood that the leaderboards and corresponding features and functionality shown in FIGS. 13A and 13B and described below are exemplary in nature and the training and evaluation platform may include any suitable format, type and number of leaderboards or similar ranking mechanisms.

FIG. 13A is a pictorial diagram illustrating a portion of the display of a training application having a leaderboard page that may be presented to users of the training and evaluation platform, according to certain embodiments. As shown in FIG. 13A, the training and evaluation platform may include leaderboard page 190, which may display a global leaderboard that lists some or all of the users of the platform in a specified order, such as based on the score or total points awarded to each user through the platform. For example, leaderboard page 190 includes a list of leaderboard users, such as leaderboard user 191, which may display various information associated with each user, such as user names 193, user scores 194, and each user's position on the leaderboard.

In certain of these embodiments, the users included on leaderboard page 190 may be ordered based on their total score in all activities performed through the platform, or they may be ordered based on their score during a specified period of time. Similarly, the users may be order based on their score on a particular type or types of activity or their scores associated with one or more domains or skills. In certain embodiments, users may be allowed to filter or customize the leaderboard based on one or more criteria, such as user role, time period, activity type, domain, etc. FIG. 13B is a pictorial diagram illustrating a portion of the display of a training application having a leaderboard page that may be presented to users of the training and evaluation platform, according to certain other embodiments. As shown in FIG. 13B, in certain embodiments, the leaderboard displayed in leaderboard page 190 may be limited to a particular group of users (e.g., players and captains), such as leaderboard 197a. In certain of these embodiments, leaderboard 197a includes a list of leaderboard users, such as leaderboard users 191a and 191b, which (like the leaderboard shown and described in FIG. 13A) may indicate certain information about each user, such as their name, organization and/or position. In certain embodiments, the user's role associated with each leaderboard user may be indicated, such as by displaying the user in a particular color, font, etc. For example, as shown in FIG. 13B, captains, such as leaderboard user 191a, may be displayed in red, while players, such as leaderboard user 191b, may be displayed in black.

As discussed above, according to certain embodiments, leaderboard page 190 may allow users to view different leaderboards and/or filter the leaderboard users based on certain criteria. For example, as shown in FIG. 13B, leaderboard page 190 may include leaderboard period selection menu 196, which may allow users to view a leaderboard based on a particular period of time, such as daily, weekly, or monthly. In certain embodiments, leaderboard page 190 may include a non-leaderboard user section, such as coaches list 197b, which may include a list of some or all of the users who are not included in the leaderboard (e.g., based on their user role), such as non-leaderboard user 191c.

FIGS. 14A-14C illustrate certain exemplary pages that may be displayed in connection with an activity rollup feature included in the training application. In certain of these embodiments, the activity rollup feature may allow certain users (e.g., captains or coaches) to review, evaluate, and/or close a particular training activity (or group of activities).

FIG. 14A is a pictorial diagram illustrating a portion of the display of a training application having an activity rollup navigation page that may be presented to users of the training and evaluation platform, according to certain embodiments. As shown in FIG. 14A, the training and evaluation platform may include activity rollup navigation page 200, which may display a list of some or all of training activities available to users through the platform. For example, activity rollup navigation page 200 may include training activity items 202a-202c. In certain of these embodiments, the training activities displayed on activity rollup navigation page 200 may be associated with the training activities that are currently accessible to users, the training activities that have recently expired (e.g., such as where the training activities are provided for a limited period) and/or the training activities that have been accessible for a certain length of time (e.g., activities that are more than a month old). In addition, or as an alternative, the training activities may be limited based on one or more user roles, training activity types, domains, etc. In certain embodiments, access to the activity rollup feature may be restricted to users associated with one or more user roles (e.g., coaches).

FIG. 14B is a pictorial diagram illustrating a portion of the display of a training application having an activity rollup summary page that may be presented to users of the training and evaluation platform, according to certain embodiments. In certain embodiments, such as where a user selects a particular training activity from the activity rollup navigation page, the training application may display activity rollup summary page 200a, which may include various general information pertaining to the selected training activity. For example, as shown in FIG. 14B, activity rollup summary page 200a may include activity summary section 204, which includes information about the training activity, such as training module name 205a and training activity name 205b. In certain embodiments, activity rollup summary page 200a may include training activity participation section 206, which may include an indication of all of the users who have performed the activity, such as training activity participant 207. As shown in FIG. 14B, training activity participant 207 may include various information about the participant, such as name, position, user role, and/or training activity score 208, which may indicate the score awarded to the participant for the training activity. Although only training activity participant 207 in shown in FIG. 14B, it should be understood that any number of training activity participants may be included in training activity participation section 206.

FIG. 14C is a pictorial diagram illustrating a portion of the display of a training application having an activity rollup activity page that may be presented to users of the training and evaluation platform, according to certain embodiments. In certain embodiments, such as where a user selects a particular training activity participant from the activity rollup summary page, the training application may display participant activity page 210, which includes various information associated with the training activity and the participant's performance in the training activity. For example, participant activity page 210 may include the training activity information, problem, the participant's responses, and/or the reviews and feedback provided by other users, such as in a similar manner to that illustrated and described in connection with FIGS. 7C and 8B.

FIGS. 15A and 15B illustrate certain exemplary pages that may be displayed in connection with favorite response feature included in the training application. In certain of these embodiments, the favorite response feature may allow users to bookmark certain responses, reviews, feedback, etc. that have been provided by other users, such as responses that the user finds helpful or important.

FIG. 15A is a pictorial diagram illustrating a portion of the display of a training application having a favorites navigation page that may be presented to users of the training and evaluation platform, according to certain embodiments. As shown in FIG. 15A, the training and evaluation platform may include favorite responses page 220 that may be presented to a user, such as when the user selects a favorite responses link on the home navigation page. In certain embodiments, favorite responses page 220 may include a list of responses that the user has previously bookmarked or flagged as a favorite. In certain of these embodiments, such as shown in FIG. 15A, the responses included in favorite responses page 220 may be separated into response categories, such as favorite text response list 222a, having favorite text response 223, and favorite voice response list 222b, having favorite voice response 224. The responses may be divided into categories based on the type of training activity, user role, date, or any other suitable criteria. In certain embodiments, the responses listed on favorite responses page 220 may include various information about each response, such as the name of the user associated with the response, the name of the training activity and training activity scores 225.

FIG. 15B is a pictorial diagram illustrating a portion of the display of a training application having a favorites activity page that may be presented to users of the training and evaluation platform, according to certain embodiments. In certain embodiments, such as where a user selects a particular response from the favorite responses page, the training application may display favorites activity page 230, which includes information associated with the training activity and performance thereof corresponding to the selected response. In certain of these embodiments, favorites activity page 230 may include information about the training activity (e.g., summary, problem, instructions, etc.), the responses provided by the training user, and/or the reviews and feedback provided by other users, such as in a similar manner to that illustrated and described above in connection with FIGS. 7C and 8B. In certain embodiments, favorites activity page 230 may include an icon or the like, such as favorites star 231, which indicates that the user has selected the response as a favorite. In certain of these embodiments, some or all of the pages that display user's responses to training activities (e.g., the pages shown in FIGS. 7C and 8A) may also include favorites star 231. In turn, users may be able to access some or all of these pages to view other user's responses and flag or bookmark favorite responses, such as by selecting the star associated with the desired response page.

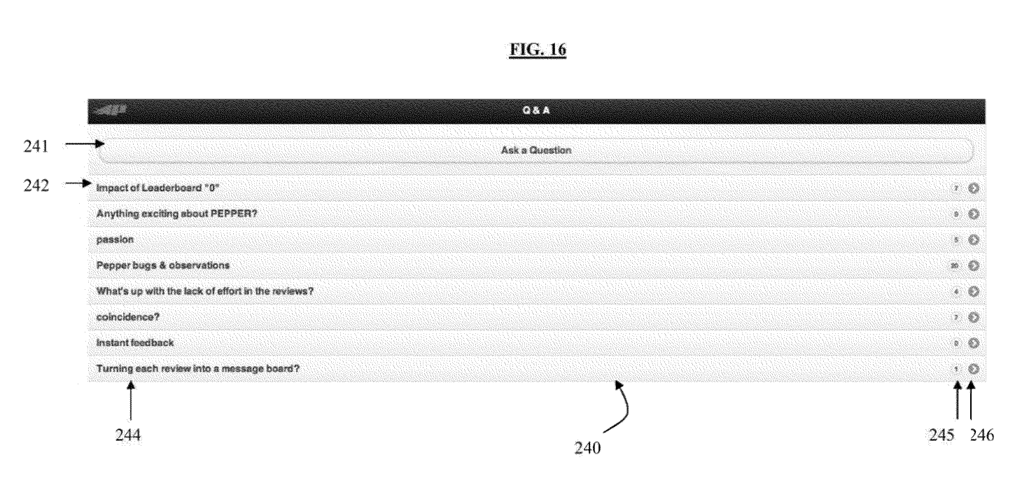

FIG. 16 is a pictorial diagram illustrating a portion of the display of a training application having a question and answer page that may be presented to users of the training and evaluation platform, according to certain embodiments. In addition to participating in various training and collaborative activities, in certain embodiments the training and evaluation platform may allow users to post questions and topics to a Question and Answer board, such as in the form of a message board or forum, and/or answer and comment on questions and topics posted by other users. For example, as shown in FIG. 16, the training and evaluation platform may include question and answer page 240, which allows users to view, navigate through, and access the questions and topics posted by other users, such as topic 242. In certain of these embodiments, question and answer page 240 may display various information associated with each topic, such as topic titles 244 and/or response quantities 245, which indicates the number of responses to the topic or question. Users may select a particular question or topic to view the original post and the responses and/or provide his or her own response and comments, such as by selecting the topic selection icons 246. In certain embodiments, question and answer page 240 may give users the option of posting new questions or topics, such as by selecting ask-a-question button 241.

According to certain embodiments, question and answer page 240 may give users the option to search through the questions and topics, such as using a keyword search. Users may also, or alternatively, be able to filter the questions and topics, such as by category, user, user role, date, number of responses, etc. In certain other embodiments, question and answer page 240 may be separated into multiple pages, each displaying the questions and topics associated with a particular category.

It is understood that the various systems and methods described in connection with the foregoing figures are exemplary, and any other suitable systems or methods may be used. The foregoing is merely illustrative of the principles of this invention and various modifications can be made by those skilled in the art without departing from the scope and spirit of the invention. As an example, although certain embodiments of the training and evaluation platform have been described in connection with certain training and collaborative activities associated with particular formats and types of activities that may be made accessible to users through the platform, the platform may include any number, format and type of training and collaborative activities. As another example, while certain embodiments of the training and evaluation platform have been described in connection with a particular group of pre-defined user roles, the platform may be implemented using any number and/or type of user roles. One skilled in the art will appreciate that the present invention can be practiced in other than the described embodiments, which are presented for purposes of illustration and not limitation, and the present invention is limited only by the claims which follow.

What is claimed is:

1. A system for encouraging regular participation in training and collaborative activities by employees of an organization, the system comprising:
a computing device having physical memory that stores:
training data associated with the organization, the training data including at least one training module having a plurality of training activities; and
user data associated with a plurality of employees of the organization; and
the computing device further including a processor coupled to the physical memory, the processor adapted to:
provide a gamified training platform adapted to allow the plurality of employees to access training and collaborative activities;
determine a training activity based on the training data, wherein the training activity is made accessible to the plurality of employees through the gamified training platform for a specified activity period;
receive training response data associated with a first employee performing the training activity;
generate a collaborative review activity based on the received training response data, the collaborative review activity pertaining to evaluating the first employee's performance of the training activity;
receive collaborative review data associated with a second employee performing the collaborative review activity;
generate a collaborative feedback activity based on the received collaborative review data, the collaborative feedback activity pertaining to rating the second employee's evaluation of the first employee's performance; and
update the user data based on at least one of the training response data and the collaborative review data;
wherein the updated user data enables an updated leaderboard indicating the relative ranking of the plurality of employees to be made accessible to the plurality of employees through the gamified training platform.

2. The system of claim 1, wherein the gamified training platform comprises a web based application accessed by the plurality of employees through the Internet and adapted for display on one or more types of mobile devices selected from the group consisting of a smartphone, a tablet, a laptop and a PDA.

3. The system of claim 1, wherein one or more of the training data and the user data are stored in at least one database that is accessed by the computing device over a network.

4. The system of claim 1, wherein the gamified training platform comprises a plurality of gamified training platforms, and wherein each of the plurality of gamified training platforms is accessible to a subset of the plurality of employees.

5. The system of claim 1, wherein the at least one training module comprises a plurality of training modules, each including a training activity type based on the plurality of training activities associated with the training module.

6. The system of claim 5, wherein the training activity type indicates a training content category associated with the organization, the training content category being selected from the group consisting of a customer, a job position, a product, a service, a policy, an area of compliance, a skill, and a field of expertise.

7. The system of claim 5, wherein the training activity type indicates a training format selected from the group consisting of multiple-choice, true-false, short answer, essay, and simulation.

8. The system of claim 1, wherein the user data includes a user role for each of the plurality of employees, the user role being selected from a plurality of predefined user roles based, at least in part, on the employee's position within the organization.

9. The system of claim 8, wherein access to at least one of the collaborative review activity and the collaborative feedback activity is restricted based on the user role associated with each employee.

10. The system of claim 1, wherein the processor is adapted to determine the training activity by determining, on a continual basis at the beginning of each specified activity period, one or more temporary training activities based on the training data, wherein the one or more temporary training activities are made accessible to the plurality of employees through the gamified training platform for the specified activity period, and wherein the specified activity period is selected from the group consisting of daily, weekly, and monthly.

11. The system of claim 1, wherein the user data includes historical activity data for each of the plurality of employees, the historical activity data including data pertaining to one or more training and collaborative activities previously performed by the employee through the gamified training platform.

12. The system of claim 11, wherein the processor is adapted to update the user data by:
updating the historical activity data associated with the first employee based on at least one of the training response data and the collaborative review data; and
updating the historical activity data associated with the second employee based on the collaborative review data.

13. The system of claim 12, wherein the processor is further adapted to:
receive collaborative feedback data associated with a third employee performing the collaborative feedback activity; and
update the historical activity data associated with at least one of the first employee, the second employee and the third employee based on the collaborative feedback data.

14. The system of claim 11, wherein the processor is further adapted to provide an employee evaluation platform adapted to assist one or more evaluators associated with the organization in tracking and analyzing the performance of the plurality of employees in training and collaborative activities through the gamified training platform based, at least in part, on the historical activity data.

15. The system of claim 11, wherein the processor is further adapted to:
receive a request for access to the updated leaderboard;
determine, in response to receiving the request, ranking data for two or more of the plurality of employees based on the historical activity data; and
generate the updated leaderboard.

16. A method for encouraging regular participation in training and collaborative activities by employees of an organization, the method comprising the steps of:
storing training data associated with the organization and user data associated with a plurality of employees of the organization, the training data including at least one training module having a plurality of training activities;
providing a gamified training platform adapted to allow the plurality of employees to access training and collaborative activities;
determining a training activity based on the training data, wherein the training activity is made accessible to the plurality of employees through the gamified training platform for a specified activity period;
receiving training response data associated with a first employee performing the training activity;
generating a collaborative review activity based on the received training response data, the collaborative review activity pertaining to evaluating the first employee's performance of the training activity;
receiving collaborative review data associated with a second employee performing the collaborative review activity;
generating a collaborative feedback activity based on the received collaborative review data, the collaborative feedback activity pertaining to rating the second employee's evaluation of the first user's performance; and
updating the user data based on at least one of the training response data and the collaborative review data;
wherein the updated user data enables an updated leaderboard indicating the relative ranking of the plurality of employees to be made accessible to the plurality of employees through the gamified training platform.

17. The method of claim 16, wherein the gamified training platform comprises a web based application accessed by the plurality of employees through the Internet and adapted for display on one or more types of mobile devices selected from the group consisting of a smartphone, a tablet, a laptop and a PDA.

18. The method of claim 16, wherein one or more of the training data and the user data are stored in at least one database that is accessed over a network.

19. The method of claim 16, wherein the gamified training platform comprises a plurality of gamified training platforms, and wherein each of the plurality of gamified training platforms is accessible to a subset of the plurality of employees.

20. The method of claim 16, wherein the at least one training module comprises a plurality of training modules, each including a training activity type based on the plurality of training activities associated with the training module.

21. The method of claim 20, wherein the training activity type indicates a training content category associated with the organization, the training content category being selected from the group consisting of a customer, a job position, a product, a service, a policy, an area of compliance, a skill, and a field of expertise.

22. The method of claim 20, wherein the training activity type indicates a training format selected from the group consisting of multiple-choice, true-false, short answer, essay, and simulation.

23. The method of claim 16, wherein the user data includes a user role for each of the plurality of employees, the user role being selected from a plurality of predefined user roles based, at least in part, on the employee's position within the organization.

24. The method of claim 23, wherein access to at least one of the collaborative review activity and the collaborative feedback activity is based on the user role associated with each employee.

25. The method of claim 16, wherein the step of determining the training activity comprises:
determining, on a continual basis at the beginning of each specified activity period, one or more temporary training activities based on the training data;
wherein the one or more temporary training activities are made accessible to the plurality of employees through the gamified training platform for the specified activity period; and
wherein the specified activity period is selected from the group consisting of daily, weekly, and monthly.

26. The method of claim 16, wherein the user data includes historical activity data for each of the plurality of employees, the historical activity data including data pertaining to one or more training and collaborative activities previously performed by the employee through the gamified training platform.

27. The method of claim 26, wherein the step of updating the user data comprises:
updating the historical activity data associated with the first employee based on at least one of the training response data and the collaborative review data; and
updating the historical activity data associated with the second employee based on the collaborative review data.

28. The method of claim 27, wherein the steps further comprise:
receiving collaborative feedback data associated with a third employee performing the collaborative feedback activity; and
updating the historical activity data associated with at least one of the first employee, the second employee and the third employee based on the collaborative feedback data.

29. The method of claim 26, wherein the steps further comprise providing an employee evaluation platform adapted to assist one or more evaluators associated with the organization in tracking and analyzing the performance of the plurality of employees in training and collaborative activities through the gamified training platform based, at least in part, on the historical activity data.

30. The method of claim 26, wherein the steps further comprise:
receiving a request for access to the updated leaderboard;
determining, in response to receiving the request to access the leaderboard, ranking data for two or more employees based on the historical activity data; and
generating the updated leaderboard.
